(19) United States
(12) Patent Application Publication
(10) Pub. No.: US 2026/0049522 A1
(43) Pub. Date: Feb. 19, 2026

(54) Systems and Methods for the Implementation of Interchangeable Door Panels

(71) Applicant: Armin Ghauforian, Coquitlam (CA)

(72) Inventor: Armin Ghauforian, Coquitlam (CA)

(21) Appl. No.: 19/370,655

(22) Filed: Oct. 27, 2025

Related U.S. Application Data
(63) Continuation-in-part of application No. 18/204,916, filed on Jun. 1, 2023, now Pat. No. 12,473,776.
(60) Provisional application No. 63/347,982, filed on Jun. 1, 2022.

(51) Int. Cl. E06B 7/28; E06B 3/30

(52) U.S. Cl. CPC E06B 7/28; E06B 3/30

(57) ABSTRACT

The present disclosure provides for an interchangeable door system. The interchangeable door system may comprise a door, designed to interface with one or more panels. The door may comprise one or more insertion mechanisms, whereby the door and the panels may be joined. The interchangeable door system may comprise one or more panels. The panels may extrude from the door to form a three-dimensional shape. The panels may comprise one or more guide pins. The panels may comprise one or more locking pins. The panels may comprise an electronic device. The panels may comprise an interactive device. The panels may comprise a storage device. The panels may comprise a securing mechanism.

### CROSS-REFERENCE TO RELATED APPLICATION

This application claims priority to and the full benefit of U.S. Nonprovisional patent application Ser. No. 18/204,916 (filed Jun. 1, 2023, and titled “SYSTEMS AND METHODS FOR THE IMPLEMENTATION OF INTERCHANGEABLE DOOR PANELS”), the entire contents of which are incorporated in this application by reference, which claimed priority to and the full benefit of U.S. Provisional Patent Application Ser. No. 63/347,982 (filed Jun. 1, 2022, and titled “SYSTEMS AND METHODS FOR THE IMPLEMENTATION OF INTERCHANGEABLE DOOR PANELS”), the entire contents of which are incorporated in this application by reference.

### BACKGROUND

For thousands of years, doors have formed an essential function as gateways and thresholds to areas of privileged admittance. Fundamentally, the door has operated as an imposed barrier that can be removed at the discretion of the owner. With this functionality mastered in the conception of the original door design, there has been little motivation to change the appearance or functionality of the door throughout time.

Truly, many doors are still made in the form of dated patterns and appearances similar to their design half a century ago. Manufacturing and demand have limited designers, architects, artists, and manufacturers to mostly mass-produced doors that have a fixed look. This mass production enables the doors to retain a lower cost for manufacture.

In the present day, most doors have a fixed façade. Once they are installed there is little to no possibility of modifying the aesthetics of the door, install ornaments and seasonal decorations, or add features and patterns without damaging the door. Most current aesthetics involve external ornamentation that is hung or attached to the outside of the door. This leaves little opportunity to integrate other ornamentation or functionality into the door without affecting the door permanently.

Due to the restrictions imposed by a generic door, any opportunity for improved utility or aesthetic appearance is lost. As an example, fortifications to strengthen doors for reasons such as an approaching storm or hurricane is often a crude set of extra materials that are attached to the door in a manner that can permanently affect the appearance of the door. This is also noticeable in demographics, such as disabled persons, who may require a modified door. Unable to modify the current door causes these people to purchase a completely new door, which is often expensive due to the customization.

### SUMMARY OF THE DISCLOSURE

What is needed is a door that may provide interchangeable utility and personalized aesthetics according to the preferences of a user. The present disclosure provides for an interchangeable door system. In some embodiments, the interchangeable door system may comprise at least one door, designed to interface with one or more interchangeable panels. In some implementations, the door may comprise one or more insertion mechanisms, whereby the door and the panel may be joined. In some aspects, the interchangeable door system may comprise one or more panels. In some embodiments, a panel may extrude from the door to form a three-dimensional shape.

In some implementations, each panel may comprise one or more guide pins. In some aspects, each panel may comprise one or more locking pins. In some embodiments, each panel may comprise one or more inserts. In some implementations, when an interchangeable door panel comprises an insert, the insert may comprise one or more inanimate objects, such as figurines. In some aspects, an insert may comprise one or more living organisms or a terrarium configured to house one or more living organisms.

In some embodiments, one or more of the panels may comprise at least one electronic device. In some implementations, the panel may comprise an interactive device. In some aspects, the panel may comprise a storage device. In some embodiments, the panel may comprise a securing mechanism.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary interchangeable door system, according to some embodiments of the present disclosure.

FIG. 1B illustrates a side-view of an exemplary interchangeable door system, according to some embodiments of the present disclosure.

FIG. 2A illustrates an exemplary interchangeable door system, according to some embodiments of the present disclosure.

FIG. 2B illustrates an exemplary interchangeable door system, according to some embodiments of the present disclosure.

FIG. 3A illustrates an exemplary insertion mechanism, according to some embodiments of the present disclosure.

FIG. 3B illustrates an exemplary door interfacing with a plurality of interchangeable door panels via a plurality of guide pins, according to some embodiments of the present disclosure.

FIG. 3C illustrates an exemplary insertion mechanism, according to some embodiments of the present disclosure.

FIG. 3D illustrates an exemplary interchangeable door panel comprising guide pins and locking pins, according to some embodiments of the present disclosure.

FIG. 3E illustrates an exemplary interchangeable door panel, according to some embodiments of the present disclosure.

FIG. 3F illustrates an exemplary locking pin, according to some embodiments of the present disclosure.

FIG. 3G illustrates an exemplary interchangeable door panel comprising electrical interfaces, according to some embodiments of the present disclosure.

FIG. 3H illustrates an exemplary interchangeable door panel comprising electrical interfaces, according to some embodiments of the present disclosure.

FIG. 4A illustrates a front view of an exemplary interchangeable door panel, according to some embodiments of the present disclosure.

FIG. 4B illustrates a rear view of an exemplary interchangeable door panel, according to some embodiments of the present disclosure.

FIG. 4C illustrates a side view of an exemplary interchangeable door panel, according to some embodiments of the present disclosure.

FIG. 5A illustrates an exemplary door of an interchangeable door system comprising a plurality of interchangeable door panels, according to some embodiments of the present disclosure.

FIG. 5B illustrates an exemplary door of an interchangeable door system comprising a plurality of interchangeable door panels, according to some embodiments of the present disclosure.

FIG. 6A illustrates an exemplary door of an interchangeable door system comprising a plurality of interchangeable door panels, according to some embodiments of the present disclosure.

FIG. 6B illustrates an exemplary door of an interchangeable door system comprising a plurality of interchangeable door panels, according to some embodiments of the present disclosure.

FIG. 7A illustrates an exemplary interchangeable door panel, according to some embodiments of the present disclosure.

FIG. 7B illustrates an exemplary interchangeable door panel, according to some embodiments of the present disclosure.

FIG. 7C illustrates an exemplary interchangeable door panel, according to some embodiments of the present disclosure.

FIG. 7D illustrates an exemplary interchangeable door panel, according to some embodiments of the present disclosure.

FIG. 7E illustrates an exemplary interchangeable door panel, according to some embodiments of the present disclosure.

FIG. 7F illustrates an exemplary interchangeable door panel, according to some embodiments of the present disclosure.

FIG. 8A illustrates a plurality of exemplary interchangeable door panels, according to some embodiments of the present disclosure.

FIG. 8B illustrates an exemplary interchangeable door panel, according to some embodiments of the present disclosure.

FIG. 8C illustrates an exemplary interchangeable door panel, according to some embodiments of the present disclosure.

FIG. 9 illustrates an exemplary interchangeable door panel, according to some embodiments of the present disclosure.

FIG. 10 illustrates an exemplary interchangeable door panel, according to some embodiments of the present disclosure.

FIG. 11 illustrates an exemplary interchangeable door panel comprising an insert, according to some embodiments of the present disclosure.

FIG. 12A illustrates an exemplary interchangeable door system comprising a door comprising an interchangeable door panel, according to some embodiments of the present disclosure.

FIG. 12B illustrates an exemplary interchangeable door system comprising a door comprising an interchangeable door panel, according to some embodiments of the present disclosure.

FIG. 12C illustrates a plurality of exemplary inserts for an interchangeable door system, according to some embodiments of the present disclosure.

FIG. 13A illustrates an exemplary interchangeable door system comprising a door comprising an interchangeable door panel, according to some embodiments of the present disclosure.

FIG. 13B illustrates an exemplary interchangeable door system comprising a door comprising an interchangeable door panel, according to some embodiments of the present disclosure.

FIG. 13C illustrates an exemplary interchangeable door panel for an interchangeable door system, according to some embodiments of the present disclosure.

FIG. 14A illustrates an exemplary door for an interchangeable door system, according to some embodiments of the present disclosure.

FIG. 14B illustrates an exemplary interchangeable door panel for an interchangeable door system, according to some embodiments of the present disclosure.

FIG. 14C illustrates a plurality of exemplary interchangeable door panels for an interchangeable door system, according to some embodiments of the present disclosure.

FIG. 14D illustrates an exemplary interchangeable door panel for an interchangeable door system, according to some embodiments of the present disclosure.

FIG. 15A illustrates an exemplary interchangeable door panel for an interchangeable door system, according to some embodiments of the present disclosure.

FIG. 15B illustrates an exemplary interchangeable door panel for an interchangeable door system, according to some embodiments of the present disclosure.

FIG. 15C illustrates an exemplary interchangeable door panel for an interchangeable door system, according to some embodiments of the present disclosure.

FIG. 16A illustrates an exemplary interchangeable door panel for an interchangeable door system, according to some embodiments of the present disclosure.

FIG. 16B illustrates an exemplary interchangeable door panel for an interchangeable door system, according to some embodiments of the present disclosure.

FIG. 16C illustrates an exemplary interchangeable door panel for an interchangeable door system, according to some embodiments of the present disclosure.

FIG. 17A illustrates an exemplary insertion mechanism for an interchangeable door system, according to some embodiments of the present disclosure.

FIG. 17B illustrates an exemplary insertion mechanism for an interchangeable door system, according to some embodiments of the present disclosure.

FIG. 18A illustrates an exemplary interchangeable door panel for an interchangeable door system, according to some embodiments of the present disclosure.

FIG. 18B illustrates an exemplary interchangeable door panel for an interchangeable door system, according to some embodiments of the present disclosure.

FIG. 18C illustrates an exemplary locking block for an interchangeable door system, according to some embodiments of the present disclosure.

FIG. 18D illustrates an exemplary locking block for an interchangeable door system, according to some embodiments of the present disclosure.

FIG. 19 illustrates an exemplary interchangeable door panel of an interchangeable door system interfacing with a computing device, according to some embodiments of the present disclosure.

FIG. 20 illustrates a front view of an exemplary interchangeable door system, according to some embodiments of the present disclosure.

FIG. 21 illustrates a view of the internal structure of an exemplary door of an interchangeable door system, according to some embodiments of the present disclosure.

FIG. 22 illustrates a detailed view of an exemplary retention mechanism for securing an interchangeable panel, according to some embodiments of the present disclosure.

FIG. 23A illustrates a detailed view of an exemplary retention clasp in a locked state, according to some embodiments of the present disclosure.

FIG. 23B illustrates the exemplary retention clasp of FIG. 23A transitioning to an unlocked state, according to some embodiments of the present disclosure.

FIG. 23C illustrates the exemplary retention clasp of FIG. 23A in a fully unlocked state, according to some embodiments of the present disclosure.

The Figures are not necessarily drawn to scale, as their dimensions can be varied considerably without departing from the scope of the present disclosure.

### DETAILED DESCRIPTION

The present disclosure provides generally for an interchangeable door system. According to the present disclosure, an interchangeable door system may comprise at least one door, designed to interface with one or more interchangeable panels. The system is configured such that the aesthetic and functional characteristics of the door's surface can be modified either by replacing a single, full-size interchangeable panel covering substantially the entire door face, or by replacing one or more of a plurality of smaller interchangeable panels arranged on the door face. In some implementations, the door may comprise one or more insertion mechanisms, whereby the door and each panel may be joined. In some aspects, the interchangeable door system may comprise one or more interchangeable panels.

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Panel: as used herein, refers to a device that at least temporarily attaches to a door. In some embodiments, a panel may interface with a door through a predefined attachment mechanism, such as an extruded slot or a recessed groove. In some implementations, a panel may comprise one or more internal subcomponents, such as, for example and not limitation, one or more electronic devices or interactive devices. In some aspects, a panel may be configured to interface with one or more of: a door or a door frame.
Insert: as used herein, refers to a material or medium that may be at least partially inserted into a panel. In some embodiments, an insert may comprise one or more materials, such as a figurine encased in epoxy. In some implementations, an insert may comprise a separate cavity for storing materials, such as, for example and not limitation, one or more removable soil inserts for planting small plants within the insert.

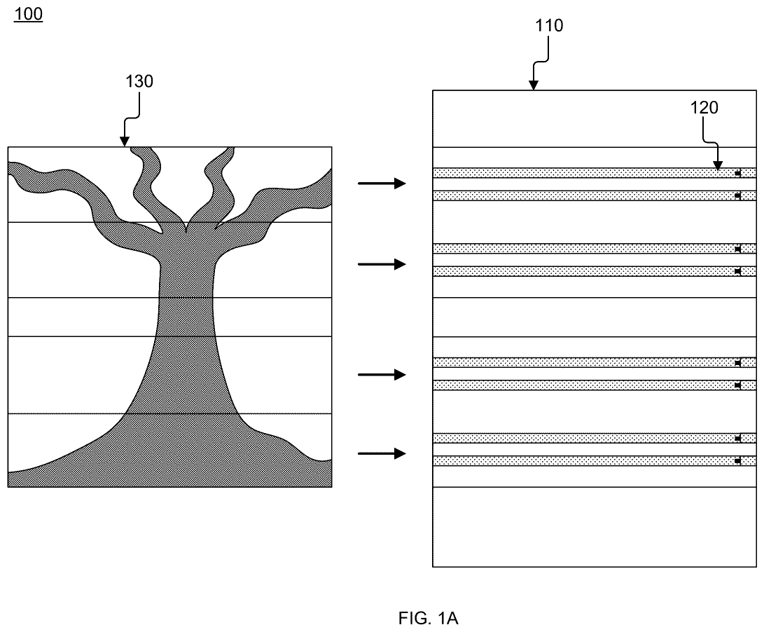

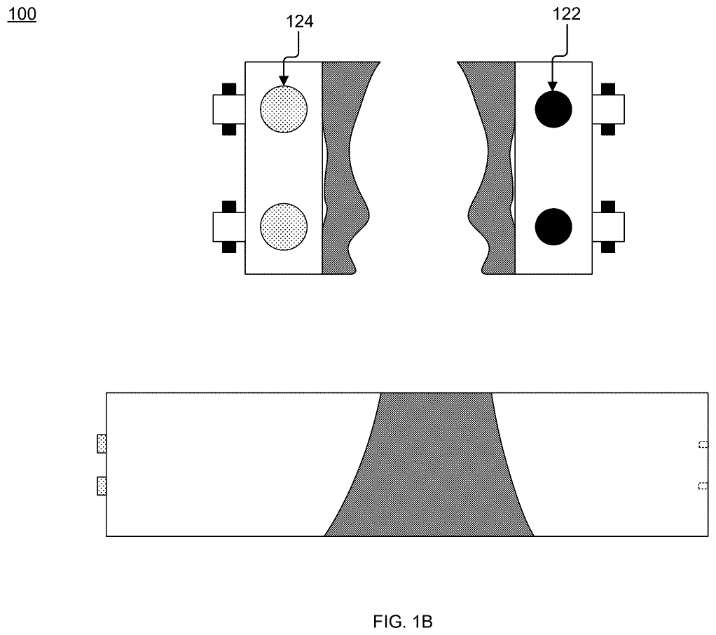

Referring now to FIGS. 1A-B, an exemplary interchangeable door system 100, according to some embodiments of the present disclosure, is illustrated. In some embodiments, the interchangeable door system 100 may comprise at least one door 110. In some implementations, the interchangeable door system 100 may comprise one or more interchangeable panels 130. In some aspects, the door 110 may comprise at least one insertion mechanism 120. In some implementations, the insertion mechanism 120 may allow the panels 130 to be removably secured or attached to the door 110. In some embodiments, the insertion mechanism 120 may comprise one or more recessed grooves within the door 110 that match the dimensions of extrusions on the panels 130.

As a non-limiting illustrative example, the door 110 may comprise insertion mechanisms 120 for three panels 130 that may comprise portions of an artistic rendering of a tree. The panels 130 may be attached to the door 110 via the insertion mechanism 120. There may be different panels of the canopy of the tree that may portray the tree in different seasons of the year. As it becomes fall, the user may remove the panel 130 containing a green tree canopy and replace it with a tree canopy comprising red, orange, and yellow leaves to indicate a fall tree canopy. The insertion mechanisms 120 and associated panels 130 may facilitate modification of the appearance or function of the door without having to replace the door.

In some aspects, each panel 130 may comprise one or more guide pins 122. In some embodiments, the guide pins 122 may interface with the insertion mechanism 120 to facilitate alignment of the panel 130 with respect to the door 110. In some aspects, the guide pins 122 may be configured to facilitate securing the panel 130 to the door 110, thereby avoiding issues such as an overhanging panel 130 lip that hits the door 110 frame as a result of partial insertion into the insertion mechanism 120.

In some implementations, each panel 130 may comprise one or more locking pins 124. In some aspects, the locking pins 124 may at least temporarily secure the panel 130 to the door 110. In some embodiments, the locking pins 124 may interface with the door frame. In some implementations, the locking pins 124 may removably secure the panels 130 via one or more screws, magnets, fasteners, or other non-limiting examples of fastening mechanisms.

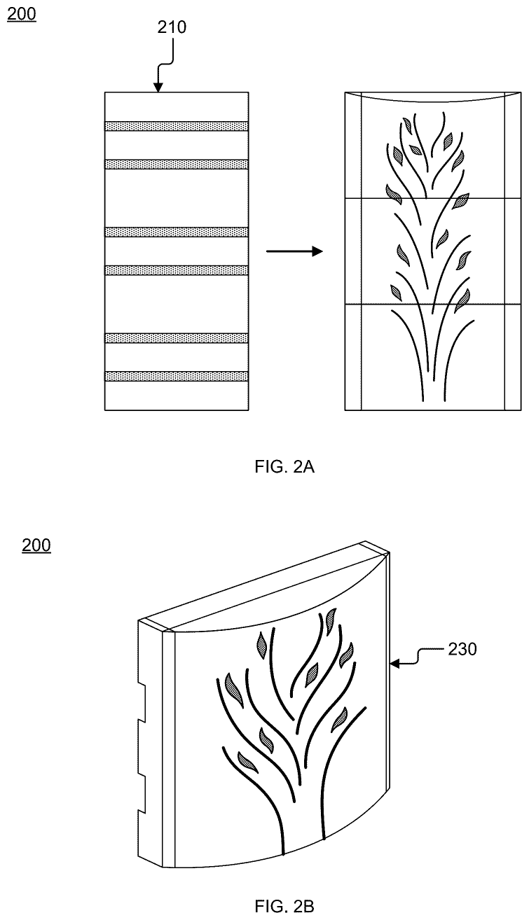

Referring now to FIGS. 2A-B, an exemplary interchangeable door system 200, according to some embodiments of the present disclosure, is illustrated. In some embodiments, the interchangeable door system 200 may comprise at least one door 210. In some implementations, the interchangeable door system 200 may comprise one or more interchangeable panels 230. In some aspects, the panels 230 may interface with the door via one or more insertion mechanisms 220.

In some embodiments, the insertion mechanisms may extrude from the door 210. In some implementations, the extrusions may allow the door 210 to retain a seal without the concern of a modified door seal as a result of recessed grooves in the surface of the door 210.

In some aspects, the panel 230 may extrude from the planar surface of the door. For example, the panel 230 may comprise a bevel that forms an extruded curvature from the surface of the door. This extrusion may provide a unique aesthetic attribute to the door 210. In some embodiments, the panel 230 may comprise insulation. The insulation may reduce heat loss through the door. In some implementations, a panel 230 extrusion may comprise hollow space to insert additional insulation.

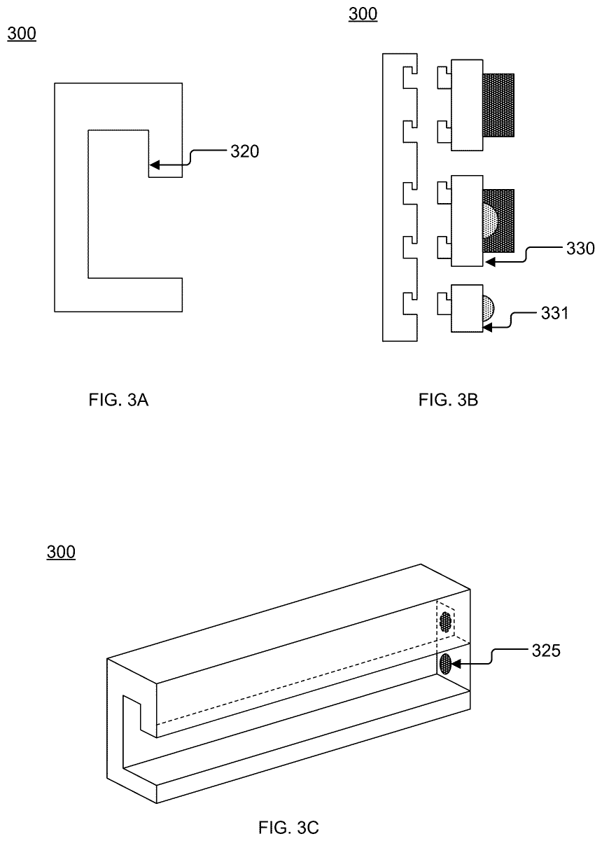

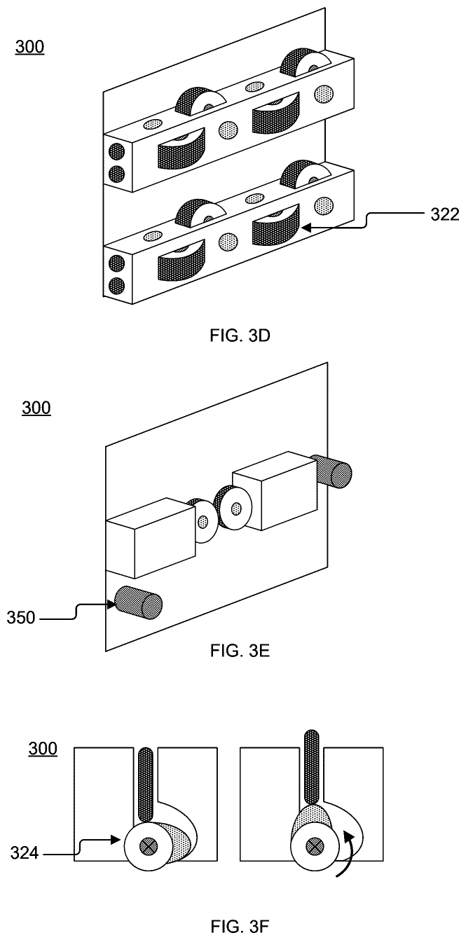

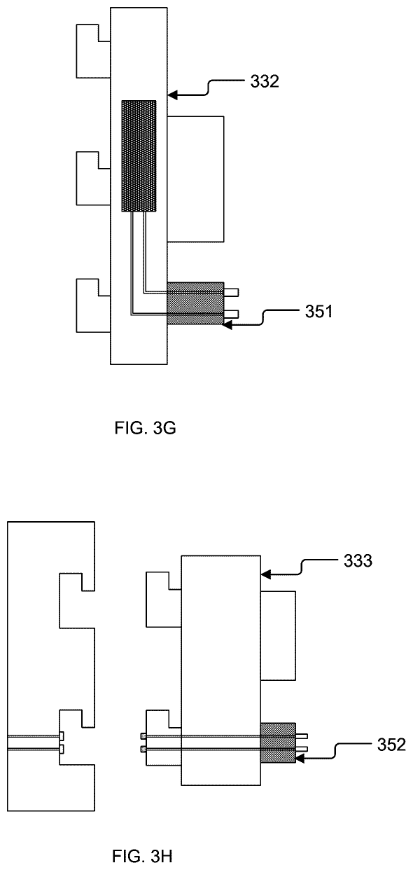

Referring now to FIGS. 3A-F, various aspects of an exemplary interchangeable door system 300, according to some embodiments of the present disclosure, are illustrated. In some embodiments, the interchangeable door system 300 may comprise one or more interchangeable panels 330. In some aspects, each panel 330 may comprise one or more guide pins 322. In some implementations, the panel 330 may comprise one or more locking pins 324.

In some implementations, the panel 330 may interface with a door via at least one insertion mechanism 320. In some embodiments, the insertion mechanism 320 may comprise at least one recessed slot within at least one internal the cavity within the door. In some implementations, the recessed slot may comprise a lip to assist in maintaining the panel 330 in parallel alignment relative to the door.

In some aspects, the insertion mechanism 320 may comprise at least one insertable slot 325 configured to interface with the locking pin 324. In some embodiments, the insertable slot 325 may at least temporarily secure the panel 330, 331 in place after the panel 330, 331 is attached to the door via the insertion mechanism 320. In some implementations, the insertable slot 325 may comprise at least one mechanical component such as a latch, a screw, a fastener, or a magnet, by way of example and not limitation, that interfaces with the locking pin 324 to form a releasably secured connection. In some embodiments, the locking pin 324 may be secured to the insertable slot 325 and accessed via the door or panel, as non-limiting options of securable access.

In some aspects, the panels 330, 331 may comprise a plurality of sizes. In some embodiments, the panels 330, 331 may comprise one or more extrusions to interface with the insertion mechanism 320, depending on the size of the panels 330, 331. In some implementations, different sized panels 330, 331 may be inserted in adjacent, complimentary positions to form a smooth, continuous surface when secured to the door.

In some aspects, the panel 330 may comprise one or more guide pins 322. In some embodiments, the guide pins may ensure precise alignment when interfacing with the insertion mechanism 320 that may provide ease and convenience when inserting and removing panels 330, 331 from the door. In some implementations, the guide pins 322 may assist in aligning secondary components embedded within the panels 330, such as an electronic device 350.

Referring now to FIGS. 3G-H, an exemplary interchangeable door panel 332, 333 comprising electrical interfaces, according to some embodiments of the present disclosure, is illustrated. In some aspects, the interchangeable door panel 332, 333 may provide external electrical interfaces for one or more electronic devices 351, 352 within the panel 332, 333. By way of example and not limitation, the electronic device 351, 352 may comprise one or more electric cables or data cords that may connect to an external source wherein alignment of the connection may be required to function properly. In some embodiments, at least one power supply cable may extend to the electronic device 351, 352 from one or more flexible hoses installed over the hinges or through the door frame. In some implementations, the cables may run through the door via one or more insulated conduits that are already configured within the insertion mechanisms 320.

In some aspects, the power supply for the electronic device 351, 352 may comprise one or more batteries installed inside the panels 332, 333. In some embodiments, a small step-down transformer may reduce the voltage for power consumption of digital and electrical devices embedded inside the door structure and panels 332, 333. As a non-limiting illustrative example, the door structure may be designed with built in conduits and push-in male-female sockets. When the panels 332, 333 are inserted, the socket at the inbound side of the panel may click into the socket inside the door facing the panel 332, 333.

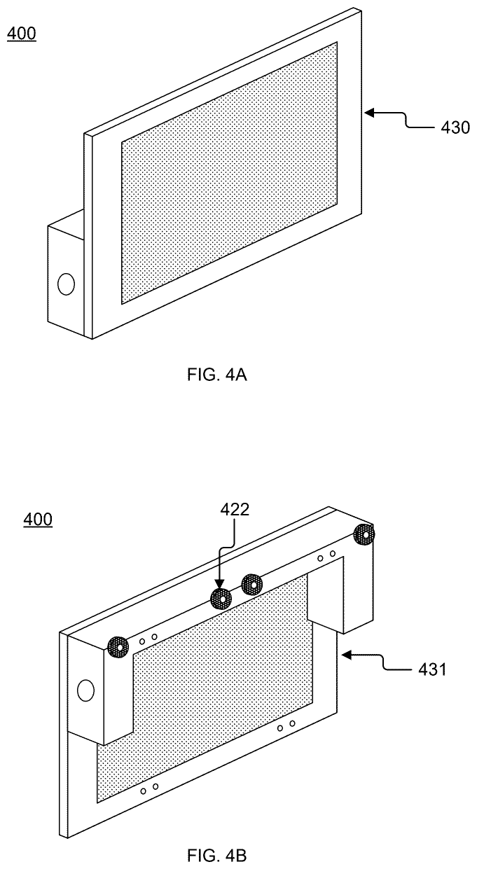

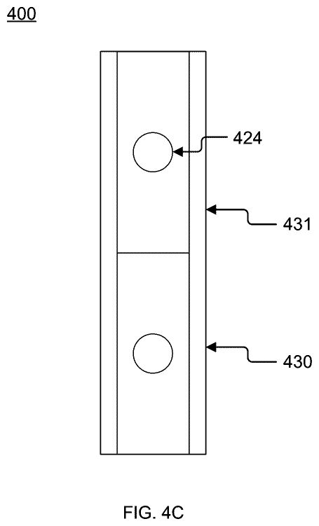

Referring now to FIGS. 4A-C, an exemplary interchangeable door panel 430, 431, according to some embodiments of the present disclosure, is illustrated. In some embodiments, the panel 430, 431 may comprise one or more guide pins 422. In some implementations, the panel 430, 431 may comprise one or more locking pins 424.

In some aspects, the panels 430, 431 may interface with each other. In some embodiments, the shapes of the panels 430, 431 may complement each other or correspond to each other. In some implementations, guide pins 422 may facilitate alignment between the panels 430, 431 and a door. In some aspects, the locking pins 424 may maintain that alignment between the panels 430, 431 and the door.

As a non-limiting illustrative example, a panel 430 may comprise an electronic device or an insertable display that requires additional depth that extends into a cavity within the door. However, if the panel 430 occupies the middle portion of the door, the opposite side of the door is inevitably exposed to a risk of an imperfect seal or gaps if the fit of the extended side of the extruded display is not completely flush with the surface of the opposite side of the door. A second panel 431 may fill unused space in the cavity of the door and provide a complimentary, flush surface for the opposite side of the door.

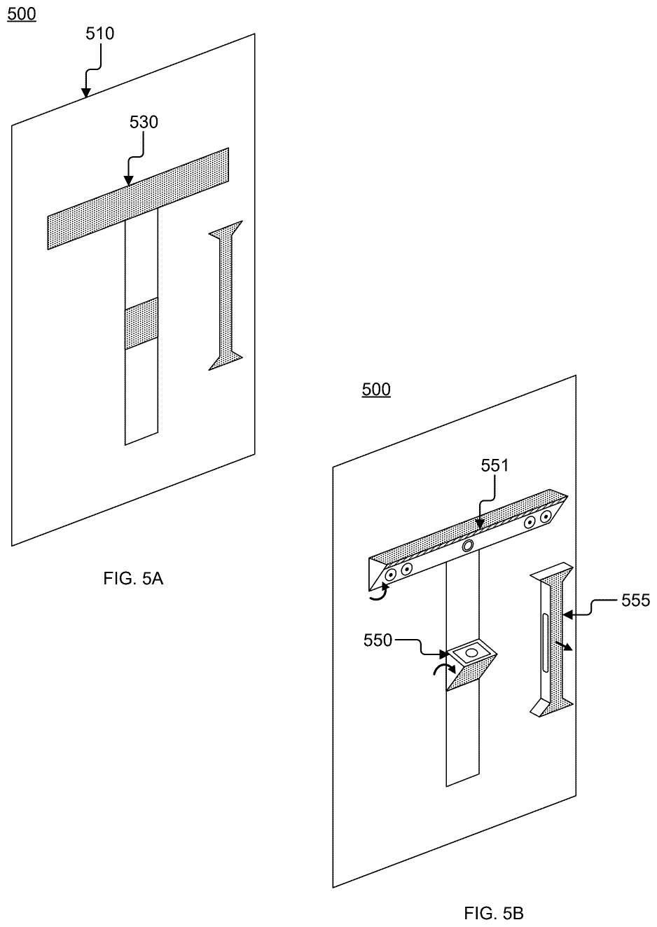

Referring now to FIGS. 5A-B, an exemplary door 510 of an interchangeable door system 500, comprising a plurality of interchangeable door panels 530, according to some embodiments of the present disclosure, is illustrated. In some embodiments, the panels 530 may comprise one or more electronic devices 550, 551. In some implementations, the door or panels may comprise at least one interactive device 555.

In some aspects, the electronic devices 550, 551 may be extendable. As a non-limiting illustrative example, a camera and set of one or more LED lights or other light emitting devices for observatory security may remain flush with the door 510 until a person is detected when approaching the door 510. The panel 530 comprising the camera and LED lights may extend from the door 510 as the person approaches to improve visibility. In some aspects, the retracted state of the electronic devices 550, 551 may provide a more aesthetic appearance and conceal the security functionality from people with harmful intentions.

In some embodiments, the electronic devices 550, 551 may provide a form of security identification. In some implementations, the electronic devices 550, 551 may comprise interactive security components such as a retinal or other biometric scanner, a speaker or other audio emitting device, a microphone, a fingerprint pad, or a touch pad, by way of example and not limitation. In some aspects, the interactive security components may interact with one or more security systems connected to other portions of a residence or may operate as a standalone security feature.

In some embodiments, the door 510 may comprise one or more panels 530 that span a plurality of insertion mechanisms. In some implementations, such panels 530 may comprise a vertical alignment. In some aspects, the panels 530 may comprise at least one interactive device 555.

As a non-limiting illustrative example, a panel 530 comprising an extrudable handle may attach to the door 510 via a top, middle, and bottom insertion mechanism. In an inactive state, the handle may remain in a retracted state, wherein the handle is flush with the surface of the door 510. As a user approaches the door and completes a security verification, the handle may extend from the surface of the door 510, allowing the user to use it to open the door 510 and enter a home or other building. In some embodiments, the interactive device 555 may provide additional security and aesthetic attributes to the door 510.

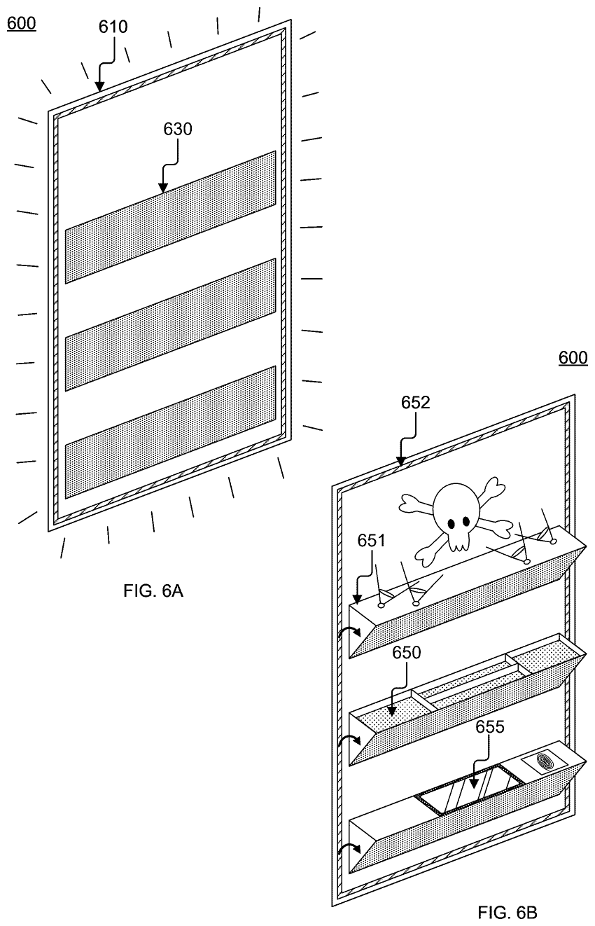

Referring now to FIGS. 6A-B, an exemplary door 610 of an interchangeable door system 600 comprising a plurality of interchangeable door panels 630, according to some embodiments of the present disclosure, is illustrated. In some embodiments, the panels 630 may comprise one or more electronic devices 650, 651, 652. In some implementations, the door 610 or panels 630 may comprise at least one interactive device 655.

In some aspects, the door 610 may comprise an electronic device 652. In some embodiments, the electronic device 652 may respond to interactions with the door 610 or the panels 630. In some implementations, the electronic device 652 may comprise sensing capabilities to activate when in proximity to a person, such as when a person approaches the door 610, by way of non-limiting example.

In some aspects, the electronic devices 650, 651 may be extendable. As a non-limiting illustrative example, a set of LED lights that project an image or animation may remain flush with the door until a person is detected when approaching the door 610. The panel 630 comprising the LED lights may extend from the door 610 as a person approaches, and a musical soundtrack may start playing. In some aspects, the retracted state of the electronic devices 650, 651 may provide a more aesthetic appearance when not in use.

In some embodiments, the panel 630 may comprise at least one interactive device 655. In some aspects, the interactive device 655 may provide a form of security identification. In some implementations, the interactive device 655 may comprise one or more interactive security components such as a retinal scanner, speaker, microphone, fingerprint pad, or touch pad, by way of example and not limitation. In some aspects, the interactive security components may be configured to interact with security systems connected to other portions of a residence or may operate in a standalone configuration.

In some embodiments, the interactive device 655 may comprise an interface for interacting with the door 610, another user, or a prerecorded program, as non-limiting examples. In some implementations, the interactive device 655 may be used to modify the settings of the electronic devices 650, 651.

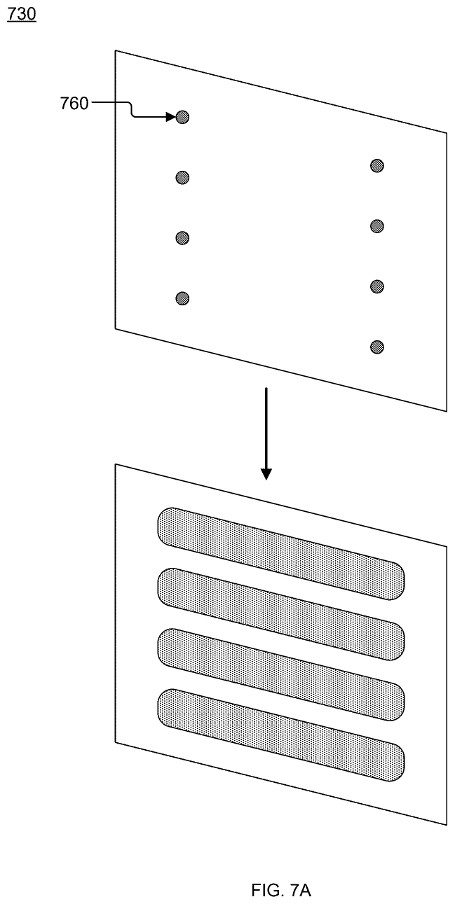

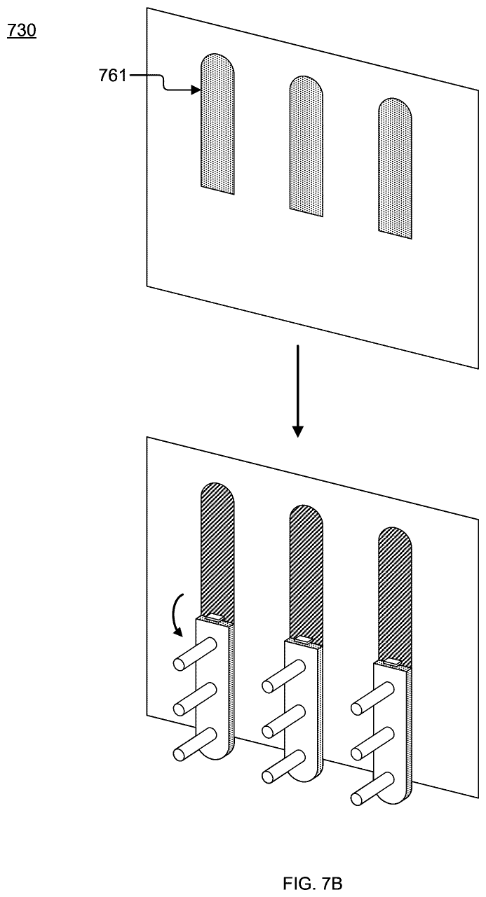

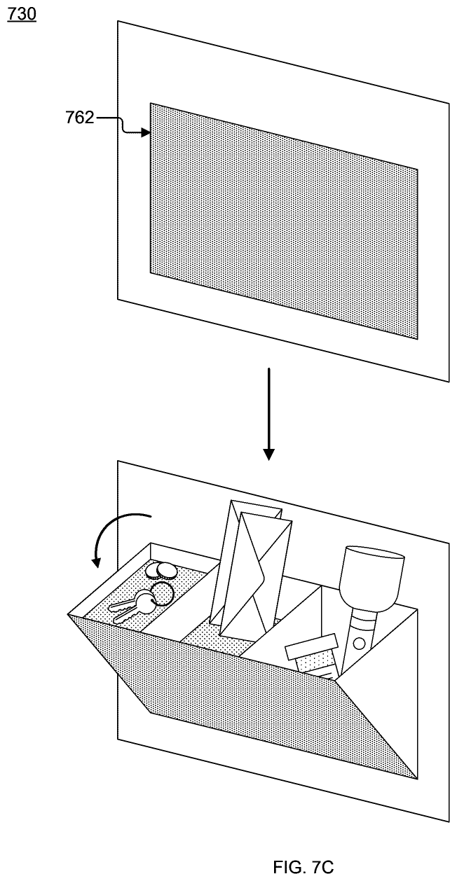

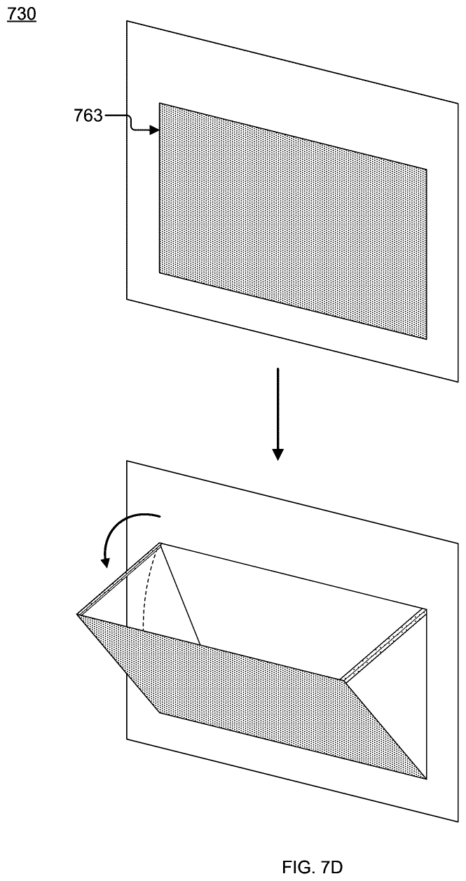

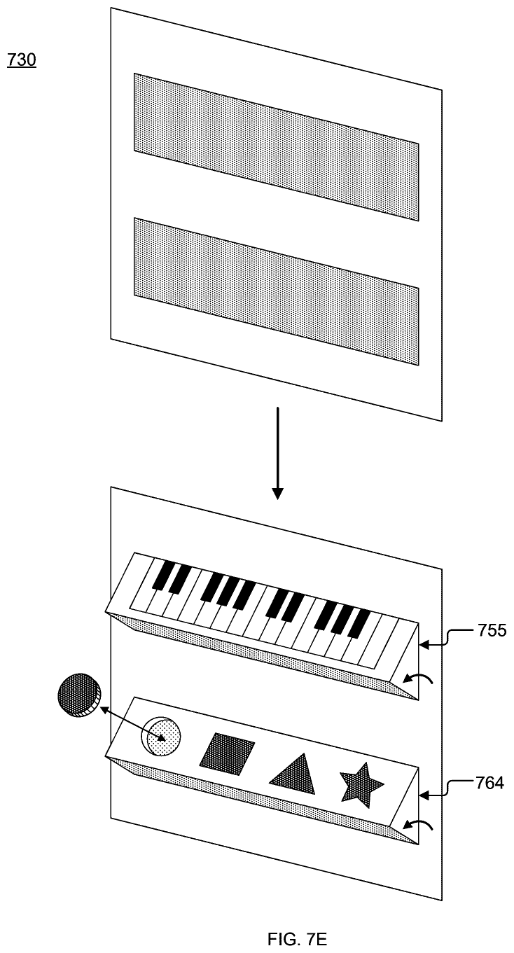

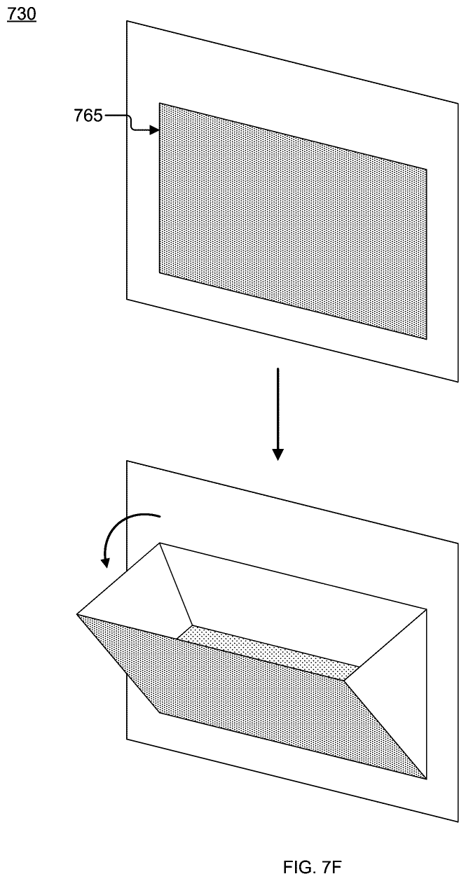

Referring now to FIGS. 7A-E, a plurality of exemplary interchangeable door panels 730, according to some embodiments of the present disclosure, are illustrated. In some embodiments, each of the panels 730 may comprise one or more storage devices 760, 761, 762, 763, 764. In some implementations, each panel 730 may comprise at least one interactive device 755.

In some aspects, the storage device 760 may comprise one or more holes or recessed grooves. In some embodiments, the storage device 760 may comprise at least one strap that fastens to the door by being inserted into the holes. In some implementations, the strap may provide a mechanism from which to hang one or more objects. In some aspects, the holes may comprise a universal size that allows one or more of a plurality of various objects to fasten to the holes.

In some embodiments, the storage device 761 may be configured to be altered between an open and closed state. In some implementations, the storage device 761 may comprise one or more pegs or other protrusions from which to hang objects. By way of example and not limitation, a plurality of pegs, in a closed state, may remain embedded within at least one cavity within a door, with the surface of the pegs remaining flush with the surface of the door. When altered to the open state, the pegs may extrude from the surface of the door to provide hanging surfaces for one or more external objects. In some aspects, the pegs may comprise one or more of a plurality of positions, such as, for example and not limitation, perpendicular to the surface of the door or at a 30-degree angle relative to the surface of the door, to hang a larger variety of objects from the storage device 761.

In some embodiments, the storage device 762, 763 may comprise at least one drawer or empty cavity in which to store one or more objects. In some implementations, the storage device 762 may comprise a plurality of smaller storage sections to further organize objects placed within the storage object 762.

In some aspects, the panel 730 may comprise at least one interactive device 755. In some embodiments, the storage device 764 may comprise one or more objects intended to remain within the storage device 764 for interactive purposes. As a non-limiting illustrative example, the panel 730 may be configured to entertain children and may comprise a small toy piano for the children to play. In some implementations, the panel 730 may comprise a plurality of shapes that may be removed and reinserted into matching shape inserts.

Referring now to FIG. 7F, another embodiment of an interchangeable panel 730 configured as a storage device, specifically a secure delivery door, is illustrated. The panel 730 includes a delivery door portion 766 that is initially flush with the main surface of the panel. The delivery door 766 is connected to the panel frame via a connector mechanism 767. This connector 767, which may include one or more hinges or pivoting arms, allows the delivery door 766 to pivot outward and downward, transitioning from a closed position to an open position, thereby granting access to an internal compartment within the panel 730 or through the door to the inside of the house. In some implementations, the connector mechanism 767 may be coupled internally to an actuator system, such as a pulley system or a motorized linkage controlled by the electronic control unit (ECU) 2170, enabling automated opening and closing.

The operation of the delivery door 766 may be controlled through various means. A user may manually operate the door via physical controls integrated into the door system, potentially located on the access control panel 2040 or controlled via the ECU 2170. Alternatively, the delivery door 766 can be controlled remotely using the mobile application on the computing device 1910, allowing the user to open or close it from anywhere. For secure deliveries, the system may be configured such that delivery personnel can open the delivery door 766 by entering a temporary, single-use access code provided by the user, consistent with the operation of the secure package delivery module described previously. Upon code entry and authentication by the ECU 2170, the delivery door 766 may automatically unlock and potentially open to receive a package.

In a further embodiment, access to the delivery door 766 may be controlled via an advanced authentication system utilizing artificial intelligence (AI). One or more cameras, such as the digital camera system 2050 described below, or dedicated cameras integrated into the panel 730, may be configured to detect the presence of delivery personnel and scan barcodes or QR codes on packages or handheld scanners. The electronic control unit (ECU) 2170, potentially utilizing an NPU, processes this visual data. Using AI algorithms, the ECU 2170 may verify the authenticity of the barcode/QR code against expected delivery information and confirm the presence of an authorized carrier signature (e.g., uniform, vehicle). Upon successful AI-driven verification, the ECU 2170 automatically unlocks and may open the delivery door 766, providing a secure, automated, and potentially code-free access method. The ECU 2170 may also send reports, including images or video clips, to the user's computing device 1910 confirming the AI-validated delivery access.

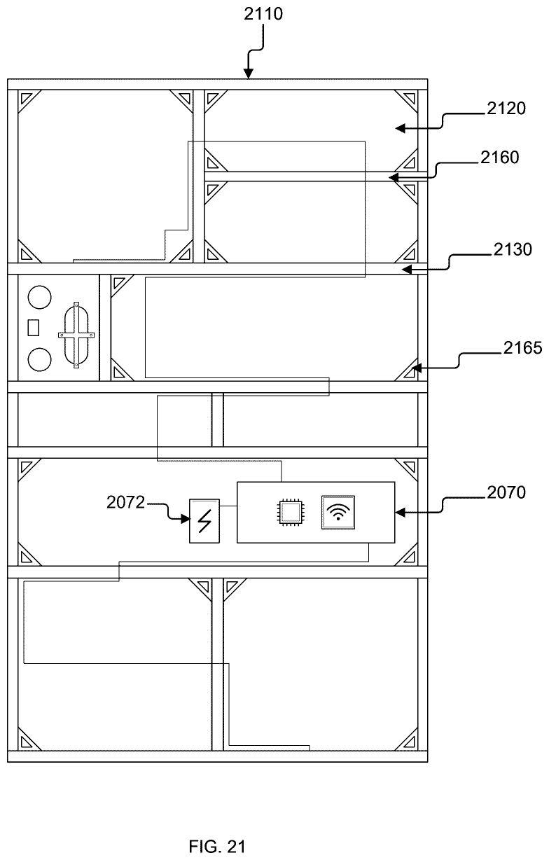

To ensure security, the delivery door 766 may be equipped with an integrated electronic locking mechanism, such as an electronically actuated bolt or latch, housed within the panel 730. This lock is communicatively coupled to and controlled by an electronic control unit (ECU), such as one shown and described in FIG. 21 2170, responding to commands initiated manually, remotely via a computing device, such as a computing device described in relation to FIG. 19 1910, or through validated access codes. Furthermore, the perimeter of the delivery door 766 or the corresponding opening in the panel 730 may include weather sealing elements, such as compressible gaskets or brush seals, to protect the internal compartment and mechanism from environmental elements like rain, dust, and drafts when the delivery door 766 is in the closed position.

The delivery door 766 may open into a secure internal compartment formed within the body of the interchangeable panel 730. This compartment may be designed such that contents placed inside are only accessible from the interior side of the main door, potentially through a separate, manually or electronically controlled interior access door or panel. The compartment itself may be constructed from durable materials and can be offered in various sizes, potentially occupying the space of multiple standard panel segments similar to the scalable module described herein. In some implementations, the compartment may be thermally insulated to better handle perishable goods. In some embodiments, the interior access door may be configured to open inwardly, opposite to the outward opening of the exterior delivery door 766, creating a secure pass-through space or tunnel effect within the compartment. The interior access door may be manually or electronically controlled. The compartment itself may be constructed from durable materials and can be offered in various sizes, potentially occupying the space of multiple standard panel segments similar to the scalable module described herein.

To enhance functionality and provide status information, the delivery door panel 730 may incorporate various sensors connected to the ECU 2170. An optical or weight sensor may be positioned within the internal compartment to automatically detect the presence of a deposited package, enabling the system to send delivery confirmation notifications or potentially prevent the exterior door 766 from being re-opened until the package is retrieved from the interior. Position sensors may be integrated with the connector mechanism 767 to provide feedback to the ECU 2170, confirming whether the delivery door 766 is fully closed and locked or in an open state. The ECU 2170 may also monitor the motor current during automated closing to detect obstructions and prevent damage or injury.

The electronic control unit (ECU) 2170, utilizing its wireless communication capabilities, may be configured to provide real-time user feedback regarding the status of the delivery door 766. Upon events such as the door being opened via access code, a package being detected within the compartment, or the door being successfully closed and locked, the ECU 2170 can generate and transmit push notifications or status updates to the user's mobile computing device 1910 via the associated mobile application. This ensures the user remains informed about delivery activities and the security state of the delivery door panel 730.

The exterior-facing delivery door portion 766 of the panel 730 can be fabricated from a variety of materials, including metal (such as steel or aluminum for security), durable polymers, or composite materials, chosen based on desired strength, weight, and appearance. Critically, the finish, color, and texture of the delivery door 766 can be customized to aesthetically match the surrounding area of the panel 730 itself, as well as any adjacent interchangeable panels 2020 installed on the main door 2010. This ensures that the functional delivery door integrates seamlessly into the overall visual design chosen by the user, maintaining the aesthetic flexibility central to the interchangeable door system.

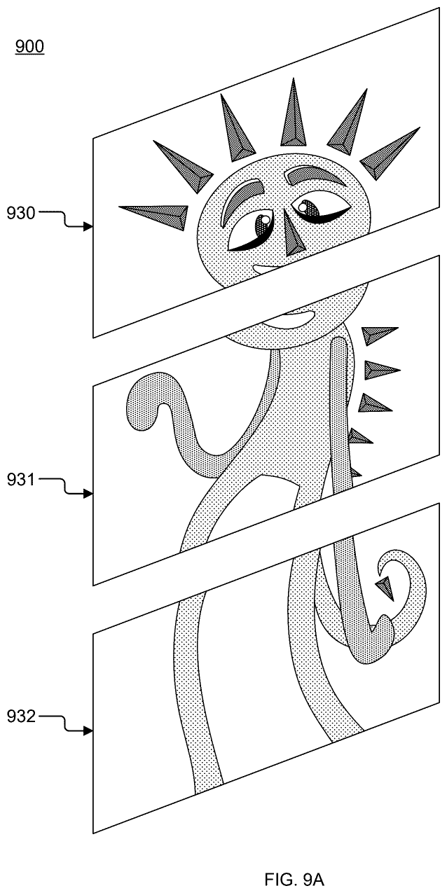

Referring now to FIGS. 8A-C, a plurality of exemplary interchangeable door panels 830, 831, 832, according to some embodiments of the present disclosure, are illustrated. In some embodiments, each of the panels 830, 831, 832 may comprise at least one electronic device 850. In some aspects, the panels 830, 831, 832 may comprise portions of a larger unitary image. In some embodiments, when the panels 830, 831, 832 are attached to a door, the panels 830, 831, 832 may form an image.

In some implementations, the formed image may be three dimensional. In some aspects, the formed image may comprise extruded portions, wherein the amount of extrusion may be adjustable. For example, lead screws may be adjusted from the side of the panel 830 to extrude a portion of the formed image. In some embodiments, the panel 830 may comprise at least one electronic device 850 that interfaces with the formed image, such as LED lights that illuminate at least a portion of the formed image, by way of example and not limitation.

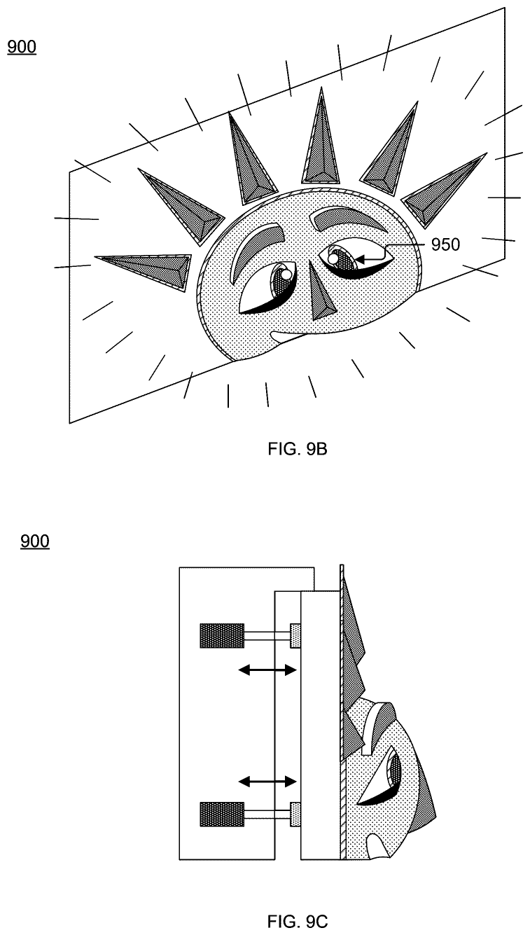

Referring now to FIG. 9, an exemplary interchangeable door panel 930, according to some embodiments of the present disclosure, is illustrated. In some embodiments, the panel 930 may comprise at least one cover 970. In some implementations, the panel 930 may comprise at least one substantially hollow portion. In some aspects, the hollow portion may facilitate interaction between both sides of the interchangeable door panel 930. In some embodiments, the cover 970 may facilitate interaction availability.

As a non-limiting illustrative example, the panel 930 may comprise a screen or similar structural configuration that allows visitors to communicate with residents of a home while remaining outside of a closed door. The screen may be physically blocked by a cover 970 when not in use, wherein the cover 970 may be retracted when the use of the screen portion is desired to communicate. The cover 970 may preserve the privacy provided by an entryway door outside of interactive situations with visitors.

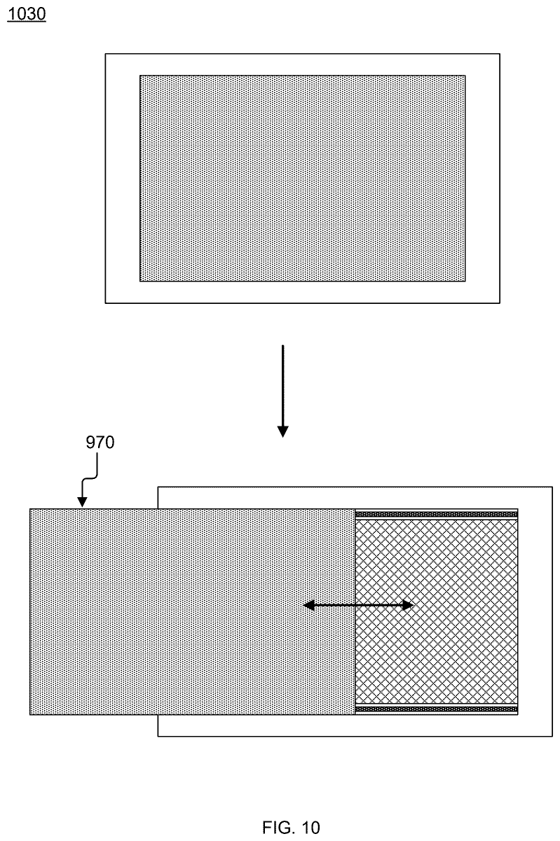

Referring now to FIG. 10, an exemplary interchangeable door panel 1030, according to some embodiments of the present disclosure, is illustrated. In some embodiments, the panel 1030 may comprise at least one cover 1070. In some implementations, the panel 1030 may comprise at least one substantially hollow portion. In some aspects, the hollow portion may provide a secondary entrance into a residence or other building through the interchangeable door panel 1030. In some embodiments, the cover 1070 may facilitate entrance availability.

As a non-limiting illustrative example, the panel 1030 may comprise an animal door to allow dogs, cats, or other pets to enter or exit a residence. At nighttime, the user may prevent exit or entrance through the animal door by securing the cover 1070. As an additional non-limiting illustrative example, the panel 1030 may comprise at least one movable portion configured to rotate about at least one axis via at least one hinge to be altered between a closed position and an open position, wherein an opening within the panel 1030 may be established when the movable portion is in the open position such that one or more packages, foodstuffs, or similar items may be passed through the opening without opening the door to which the panel 1030 may be attached. In some embodiments, at least one actuator, such as, for example and not limitation, a piston-driven rod or a mechanical arm or lever, may facilitate the transition of the movable portion between the open and closed positions. In some implementations, one or more sensing devices may be integrated with the panel 1030 such that the sensing devices may detect when an approved animal (such as, for example and not limitation, a household pet) is approaching the panel 1030 or when an approved human is approaching with an item for delivery and thereby utilize such detection to automatically open the movable portion of the panel 1030 to facilitate pet ingress or egress or item delivery without having to disrupt the user.

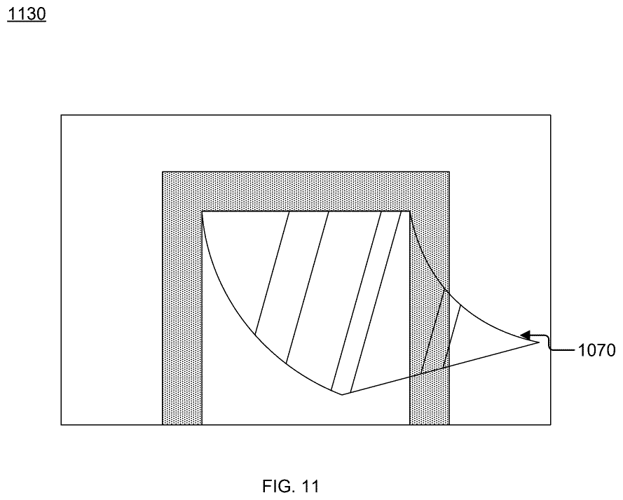

Referring now to FIG. 11, an exemplary interchangeable door panel 1130 comprising an insert 1140, according to some embodiments of the present disclosure, is illustrated. In some embodiments, the panel 1130 may comprise at least one cover 1170. In some implementations, the panel 1130 may comprise at least one insert 1140. In some aspects, the panel 1130 may comprise at least one substantially hollow portion.

In some embodiments, an insert 1140 may at least temporarily occupy at least a portion of the hollow portion of the panel 1130. In some implementations, the insert 1140 may be removable. In some aspects, the insert 1140 may be interchangeable. In some embodiments, the insert 1140 may comprise at least one at least partially transparent portion. In some implementations, the cover 1170 may provide privacy while displaying an insert 1140.

As a non-limiting illustrative example, an insert 1140 may comprise a prominent figurine that is displayed in an epoxy casing. On the interior side of the interchangeable door panel, a resident may keep the cover 1170 closed to prevent visitors from looking through the epoxy and seeing inside the residence.

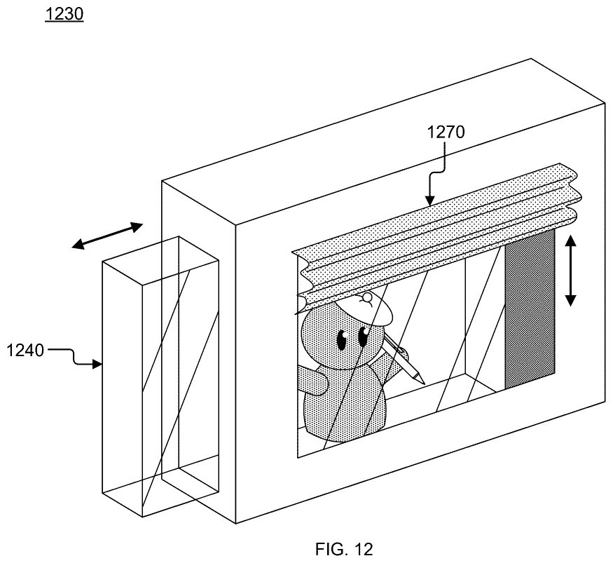

Referring now to FIGS. 12A-C, various aspects of an interchangeable door system 1200, according to some embodiments of the present disclosure, are illustrated. In some aspects, the interchangeable door system 1200 may comprise at least one door 1210. In some embodiments, the door 1210 may comprise at least one interchangeable door panel 1230. In some aspects, the panel 1230 may comprise at least one insert 1240. In some implementations, the panel 1230 may comprise one or more locking pins 1223, 1224.

In some implementations, the panel 1230 may comprise at least one insert 1240. In some aspects, the panel 1230 may comprise at least one substantially hollow portion. In some embodiments, an insert 1240 may at least partially occupy at least a portion of the hollow portion of the panel 1230. In some implementations, the insert 1240 may be removable. In some aspects, the insert 1240 may be interchangeable.

In some embodiments, the panel 1230 may comprise a frame to interface with the insert 1240, 1241. In some implementations, the panel 1230, 1231 may comprise one or more locking pins 1223 to at least temporarily secure the panel 1230, 1231 to the door 1210. In some aspects, the insert 1240, 1241 may comprise one or more locking pins 1224 to at least temporarily secure the insert 1240, 1241 to the panel 1230, 1231. In some embodiments, the locking pins 1224 may provide a convenient method of interchangeability to change inserts 1240, 1241.

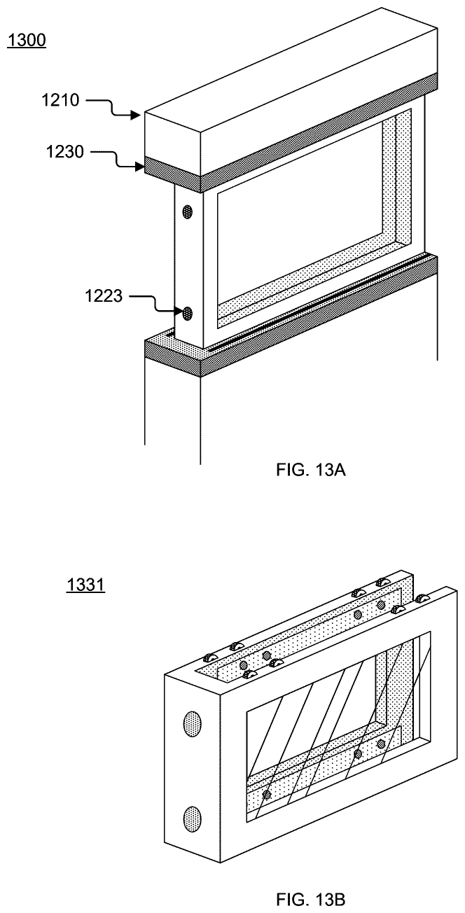

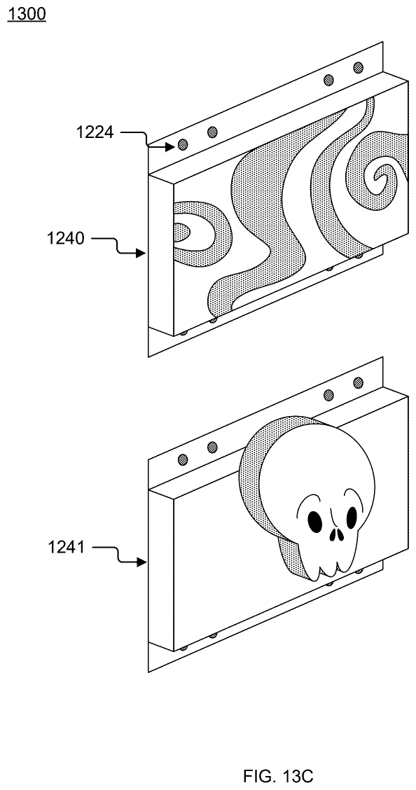

Referring now to FIGS. 13A-C, an exemplary interchangeable door system 1300 comprising a door 1310 comprising an interchangeable door panel 1330, according to some embodiments of the present disclosure, is illustrated. In some embodiments, the panel 1330 may comprise at least one securing mechanism 1365. In some implementations, the securing mechanism 1365 may be configured to fortify the door 1310. In some aspects, the securing mechanism 1365 may be configured to extend from the panel 1330 when activated.

As a non-limiting illustrative example, the panel 1330 may comprise a securing mechanism 1365 that comprises a plurality of large metal bars that, when activated, fortify the door 1310 from break-ins by extruding from the panel 1330 to extend beyond the frame of the door 1310, thereby using the walls of the residence or building as reinforcement for maintaining the door 1310 in a closed position.

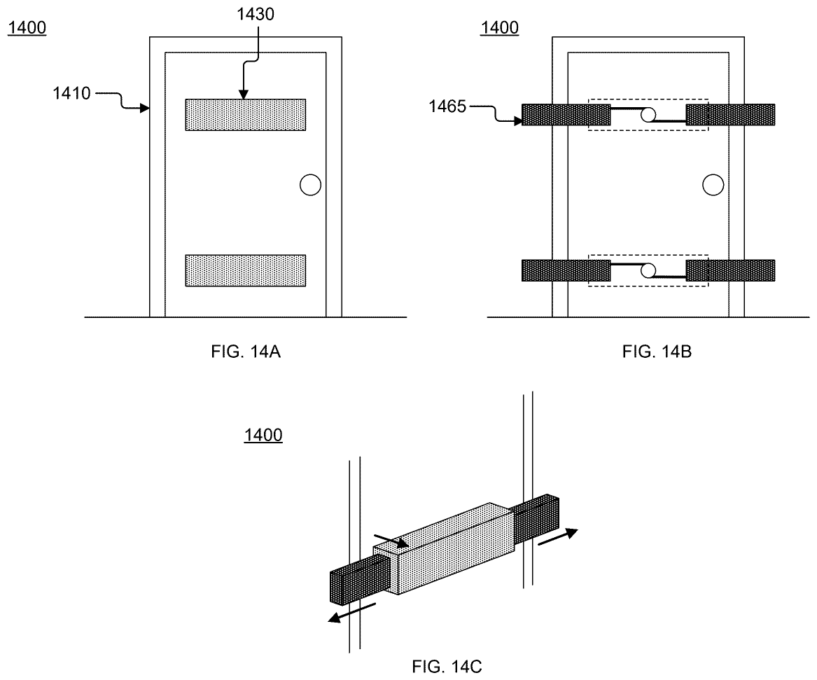

Referring now to FIGS. 14A-D, an exemplary interchangeable door panel 1430 for an interchangeable door system 1400, according to some embodiments of the present disclosure, is illustrated. In some aspects, the interchangeable door system 1400 may comprise at least one door 1410. In some implementations, the interchangeable door system 1400 may comprise one or more interchangeable panels 1430. In some embodiments, the door 1410 may comprise a plurality of recessed insertion mechanisms to at least temporarily secure the panels 1430 to the door 1410. In some implementations, the panels 1430 may comprise one or more locking pins 1424.

In some aspects, the locking pins 1424 may unify the panels 1430. In some embodiments, the locking pins 1424 may secure a plurality of the panels 1430 to the door 1410. As a non-limiting illustrative example, the panels 1430 may form a reinforced panel block when joined by the locking pins 1424 that may provide a fortified door for added security or storm reinforcement. The locking pins 1424 may unify the panels 1430 sufficiently to transform the panels 1430 into a storm fortification for hurricanes and similar natural disasters. In some implementations, one or more guide pins 1422 may be configured to facilitate securing the panels 1430 in place and aligning the panels 1430 with the door 1410. In some aspects, this may further strengthen the fortification of the panels 1430 attached to the door 1410.

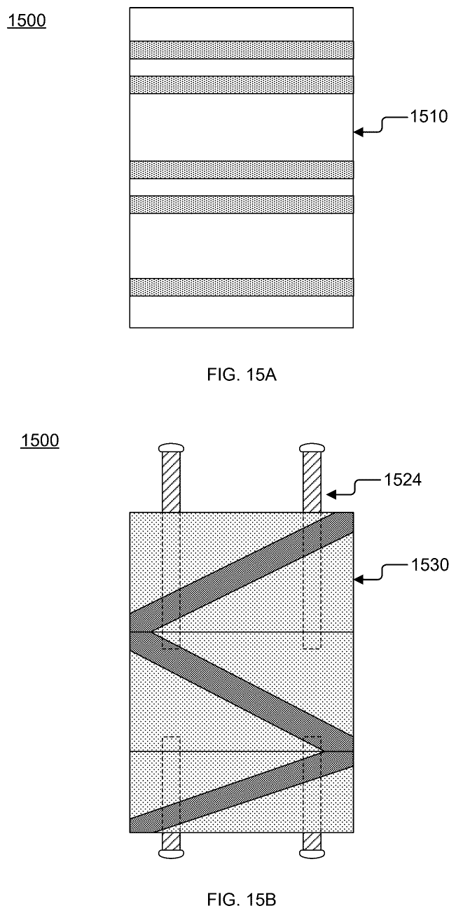

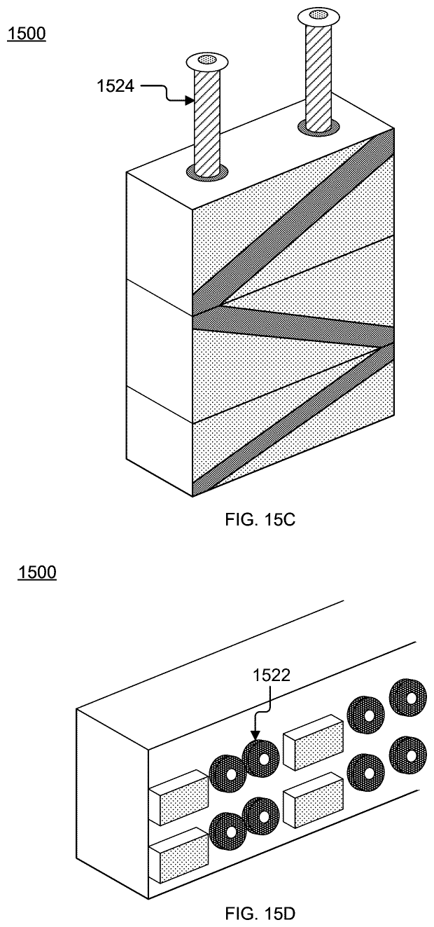

Referring now to FIGS. 15A-C, exemplary interchangeable door panels 1530, 1531, 1532 for an interchangeable door system 500, according to some embodiments of the present disclosure, are illustrated. In some embodiments, the interchangeable door system 500 may comprise at least one door 1510. In some implementations, the interchangeable door system 1500 may comprise at least one cover 1570. In some embodiments, the cover 1570 may provide privacy if the insertable door panel 1500 comprises at least one at least partially transparent region.

In some aspects, the interchangeable door system 1500 may comprise one or more panels 1530, 1531, 1532. In some embodiments, the panel 1530 may comprise at least one electronic device 1550. In some implementations, the electronic device 1550 may comprise at least one insert that is configured for interchangeability. In some aspects, the electronic device 1550 may be configured to interface with at least one external device. In some embodiments, the electronic device 1550 may be configured to display information.

As a non-limiting illustrative example, the door 1510 may be configured to facilitate access to a business meeting room, wherein the door 1510 may comprise at least one screen that displays information for the next appointment that will occupy that meeting room. The screen may maintain a remote connection to a computer that routinely updates the schedule on the screen in the event of schedule changes or cancellations. In some aspects, the remote connection may also allow a user to add information to the screen, such as temporary company announcements.

In some implementations, the panel 1531, 1532 may comprise one or more living organisms. By way of example and not limitation, the panel 1531 may comprise a terrarium that provides soil and water for a plurality of plants. Such panel 1531 may be used to create a decorative door 1510 found in an office or workplace. As another non-limiting illustrative example, the panel 1532 may comprise an ant farm that is attached to the door 1510 of a biology classroom. In some aspects, the panel 1531, 1532 may comprise an insert to provide maintenance to the living organisms therein or to switch displays.

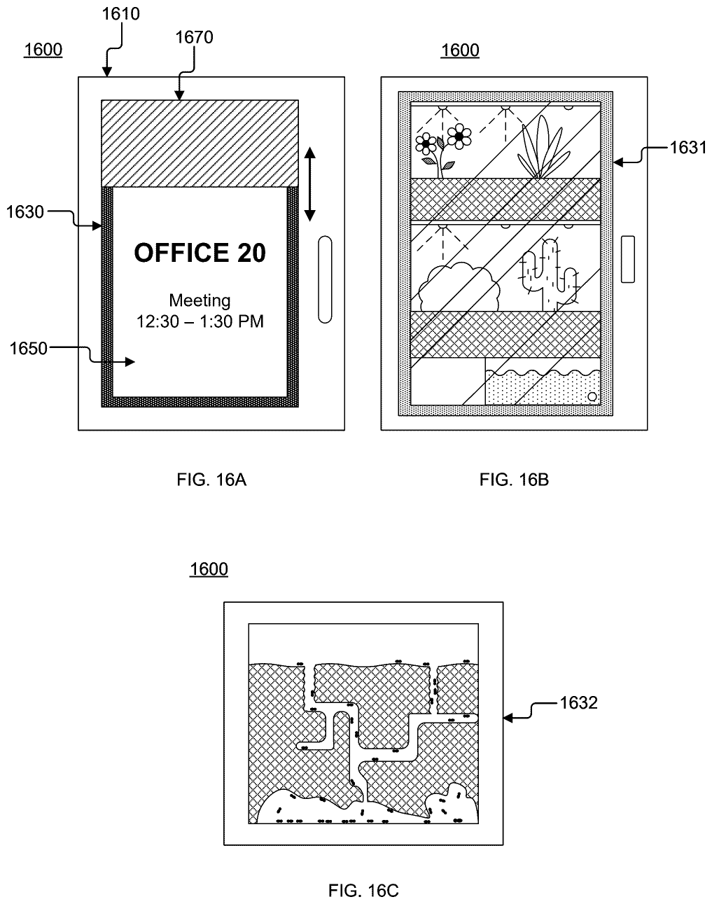

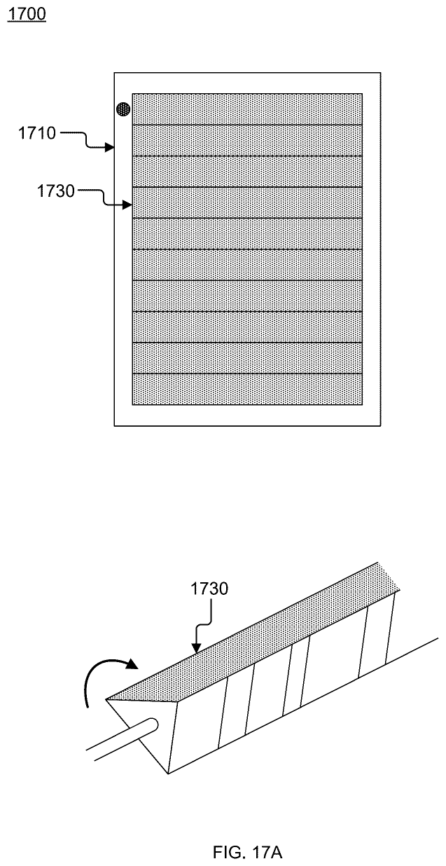

Referring now to FIGS. 16A-C, an exemplary interchangeable door panel 1630 for an interchangeable door system 1600, according to some embodiments of the present disclosure, is illustrated. In some embodiments, the interchangeable door system 1600 may comprise at least one door 1610. In some implementations, the interchangeable door system 1600 may comprise a plurality of panels 1630.

In some aspects, each of the panels 1630 may comprise two or more displayable surfaces. In some embodiments, the panels 1630 may be configured to rotate to display one of a plurality of predetermined displayable surfaces. As a non-limiting illustrative example, the panels 1630 may comprise a first displayable surface that is reflective, such that when the first displayable surface is displayed in conjunction with the other panels 1630, a mirror may be formed. On another side of the same panel 1630, a second displayable surface may comprise a portion of an image. When this side is displayed in conjunction with the other panels 1630, the panels 1630 may form an image on the door 1610.

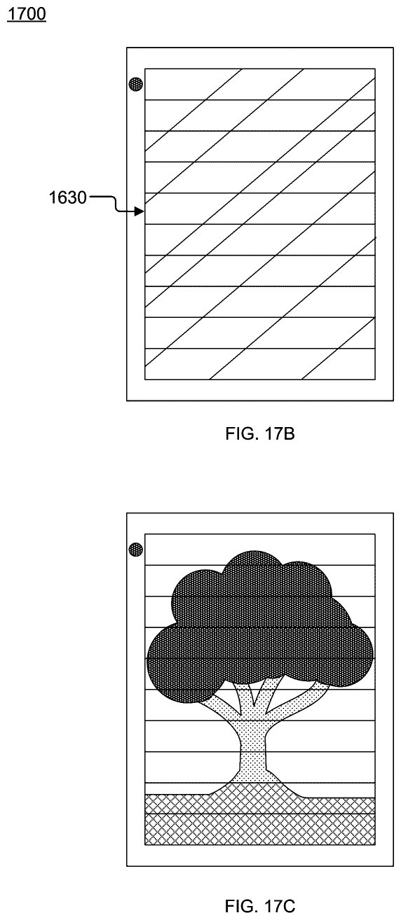

Referring now to FIGS. 17A-B, an exemplary insertion mechanism 1720 for an interchangeable door system 1700, according to some embodiments of the present is disclosure, is illustrated. In some aspects, the interchangeable door system 1700 may comprise at least one interchangeable panel 1730, wherein the panel 1730 may be configured to interface with at least one door via at least one insertion mechanism 1720. In some embodiments, the insertion mechanism 1720 may comprise at least one guide rail and at least one slidable bar, wherein at least a portion of the guide rail may be temporarily or permanently affixed to or integrated with the panel 1730. In some implementations, at least a portion of the slidable bar may be temporarily or permanently affixed to or integrated with the door. In some aspects, the bar may be slidable to achieve linear translational movement within the guide rail such that the bar may be received by the guide rail of panel 1730 when the bar is inserted into and slid within the guide rail. In some non-limiting exemplary embodiments, the slidable bar may be configured to at least temporarily lock in at least one position.

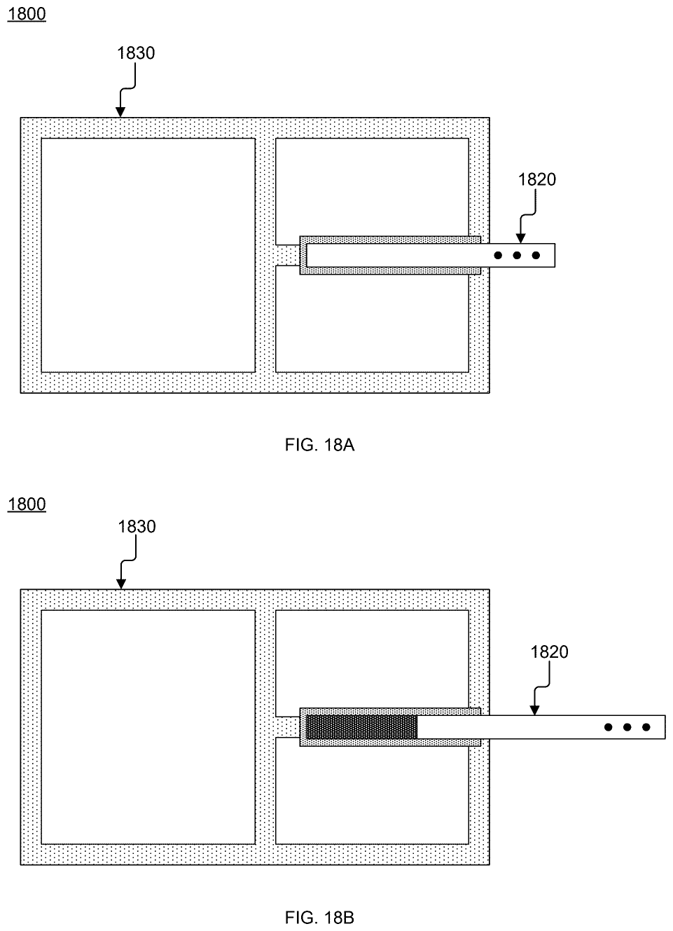

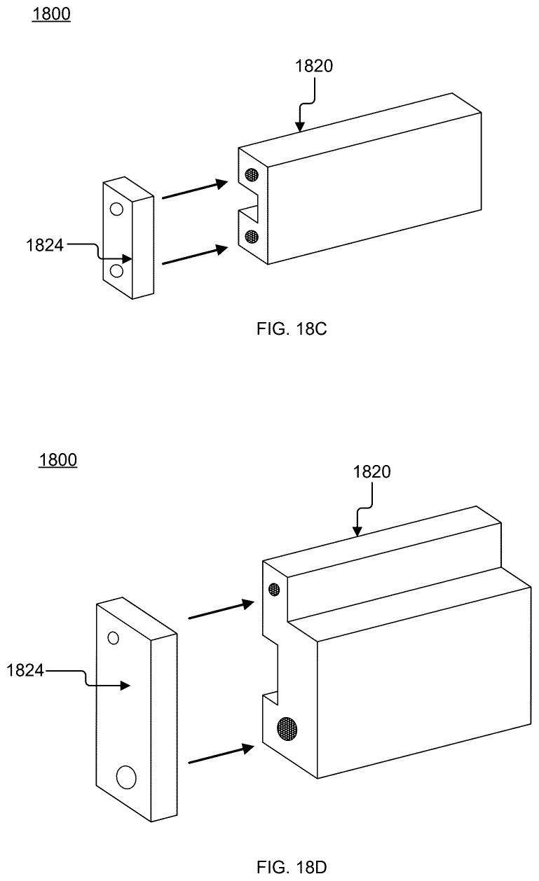

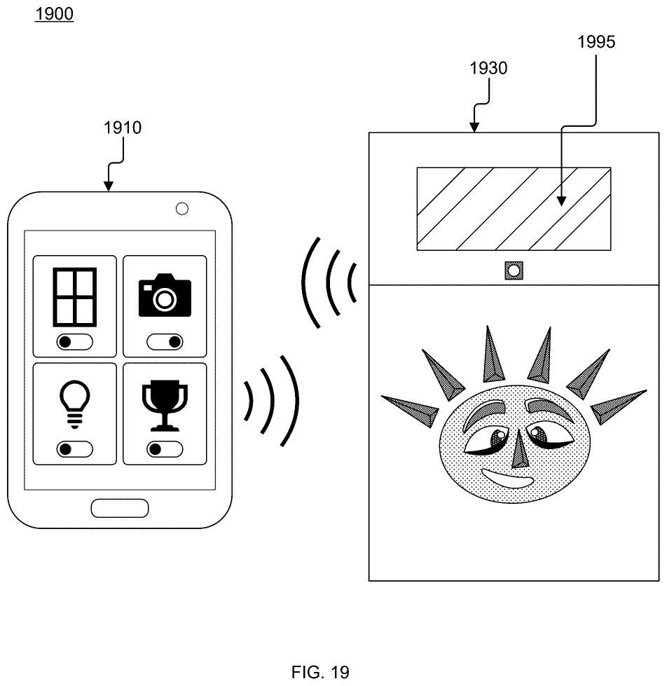

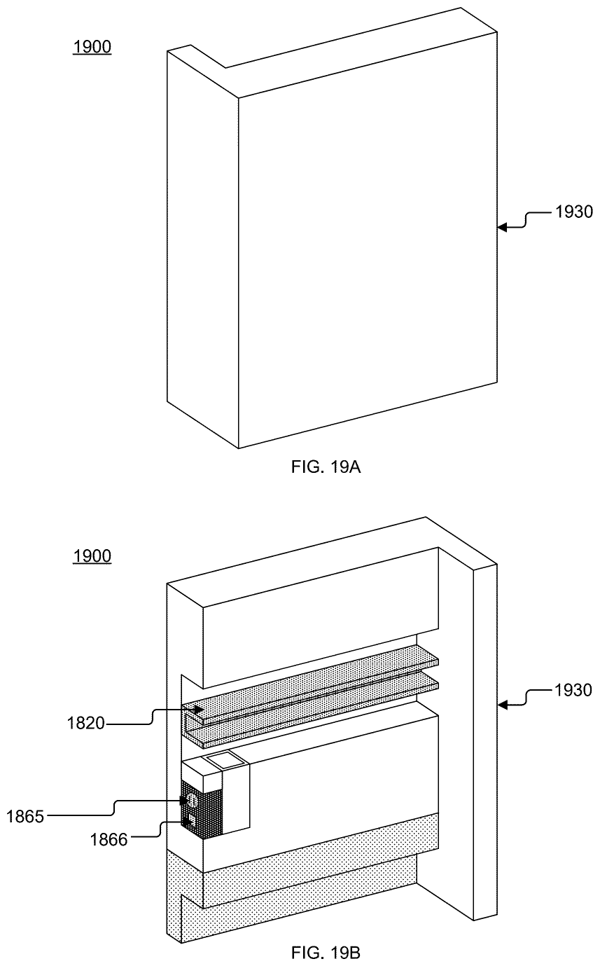

Referring now to FIGS. 18A-D, exemplary interchangeable door panels 1830 and exemplary locking blocks 1824 for an interchangeable door system 1800, according to some embodiments of the present is disclosure, are illustrated. In some aspects, the panel 1830 may comprise an internal frame that comprises at least one insertion mechanism in the form of a guide rail 1820 that may be configured to receive a slidable bar of at least one door. In some implementations, the inner frame of the panel 1830 may comprise at least one conduit 1860, wherein one or more cables, cords, light-emitting diodes (“LEDs”), or similar elements may be configured. In some embodiments, a side surface of the panel 1830 may comprise one or more push-fit style power connectors 1865 and/or data connectors 1866 to facilitate the flow or transmission of data and/or electricity to and/or from panel 1830.

In some implementations, the panel 1830 may comprise a metallic and/wooden frame, such as, for example and not, an aluminum and/or plywood frame. In some embodiments, one or more interior portions of the frame may comprise one or more layers of insulating materials, such as, for example and not limitation, polyvinyl chloride, one or more polycarbonates or thermoplastic polymers, or an amount of aerogel.

In some non-limiting exemplary implementations, the interchangeable door system 1800 may comprise a door frame, wherein one or more portions of the door frame may comprise one or more pivoting or rotating elongated tabs or flaps configured to be altered between a sealed state and an unsealed state, wherein the elongated tabs are configured to achieve the sealed state to form a seal around an outer edge of a door to which the panel 1830 may be attached when the door is closed, while pivoting or rotating to the unsealed state to release the door when a minimum threshold amount of force is applied to the door. In some embodiments, the elongated tabs may be biased towards the sealed state and the unsealed state, such as, for example and not limitation, via one or more compression or extension springs, such that once a minimum threshold amount of force is applied, the tabs transition from one state to the other.

In some aspects, the guide rail 1820 may be configured to interface with a slidable bar or similar element of at least one door. In some implementations, the panel 1830 may comprise at least one locking block 1824, wherein the locking block 1824 may be configured to at least temporarily secure the panel 1830 to the door when one or more protrusions at a distal end of the guide rail 1820 are securely received within one or more slots, recesses, or apertures within the locking block 1824, such as, for example and not limitation, by forming a snap-fit configuration. In some aspects, the locking block 1824 may comprise metal, wood, or plastic, as non-limiting examples.

Referring now to FIG. 19, an exemplary interchangeable door panel 1930 of an interchangeable door system 1900 interfacing with a computing device 1910, according to some embodiments of the present, is illustrated. In some aspects, the panel 1930 may comprise at least one display mechanism 1995. In some implementations, the display mechanism 1995 may at least partially comprise smart glass. In some embodiments, the display mechanism 1995 may comprise a display screen or monitor, wherein at least a portion of the display screen may comprise a touchscreen interface. By way of example and not limitation, the display mechanism 1995 may be configured to present or display one or more of: a live or recorded feed from one or more cameras configured on an outer surface of the panel 1930; one or more photographs, images, or videos; artwork; a weather forecast; or a calendar or schedule.

In some implementations, the panel 1930 may comprise sufficient hardware, such as at least one controller and at least one transmitting device, to allow the panel 1930 to connect and exchange data with at least one external computing device 1910. In some aspects, the computing device 1910 may comprise a mobile device, such as a mobile phone, smartwatch, or tablet, as non-limiting examples. In some implementations, the computing device 1910 may comprise one or more coded software instructions that, when executed by at least one processor of the computing device 1910, cause the computing device 1910 to generate and display at least one graphical user interface 1900. In some aspects, this may allow a user to remotely control and interact with the various electrical components of the interchangeable door panel 1930, as well as any electronic or computing devices communicatively coupled thereto. As an illustrative example, a user may instruct the display mechanism to display a certain image from the mobile device.

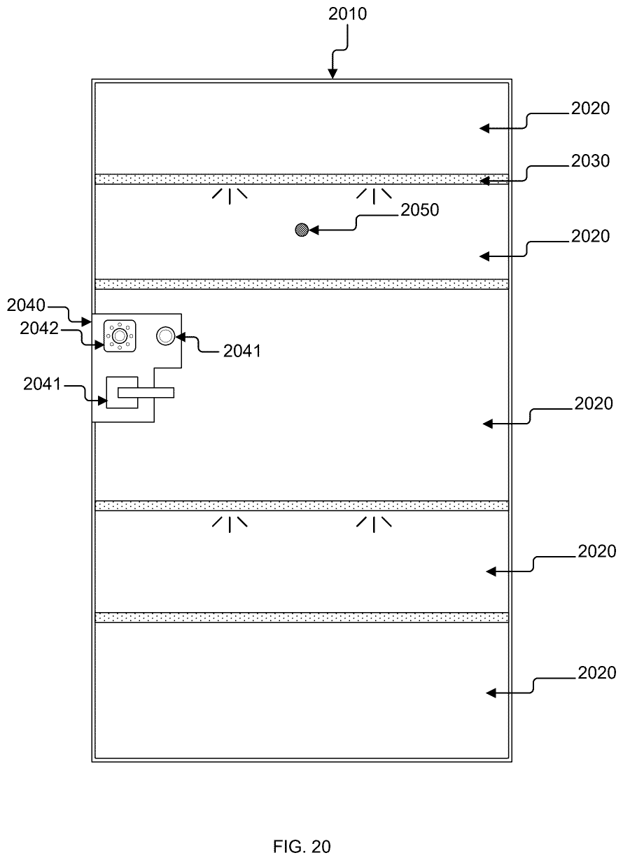

Referring now to FIG. 20, a front view of an exemplary interchangeable door system 2000, according to some embodiments of the present disclosure, is illustrated. The system includes a door 2010 configured to receive a plurality of interchangeable panels 2020. The interchangeable panels 2020 are arranged in a stacked configuration, separated by one or more dividers 2030, which may be structural, decorative, or include integrated electronic features such as accent lighting. The interchangeable door system 2020 includes an access control panel 2040, integrating an entry interface assembly. This assembly may comprise a door handle 2041 and an electronic locking mechanism 2042, which may include features such as a digital keypad, a biometric scanner, and/or a physical key entry point 2043. In some embodiments, another of the panels 2020 may feature a peephole 2050 for viewing the area outside the door 2010.

In other embodiments, the configuration of components on the door 2010 may vary. The entry interface assembly 2040, for example, may be purely mechanical, comprising only a handle or a doorknob, and a traditional key lock, foregoing the electronic locking mechanism 2042. Alternatively, the components of the assembly, such as the handle 2041 and lock 2042, may be located on one of the interchangeable panels 2020. The peephole 2050 may be implemented as a digital device, comprising a wide-angle camera communicatively coupled to an interior display screen, consistent with the system described in FIG. 19. Furthermore, the dividers 2030 may function as adjustable tracks, allowing the vertical position of each panel 2020 to be modified. The lighting integrated within the dividers 2030 may comprise color-changing LEDs controllable by an external computing device 1910.

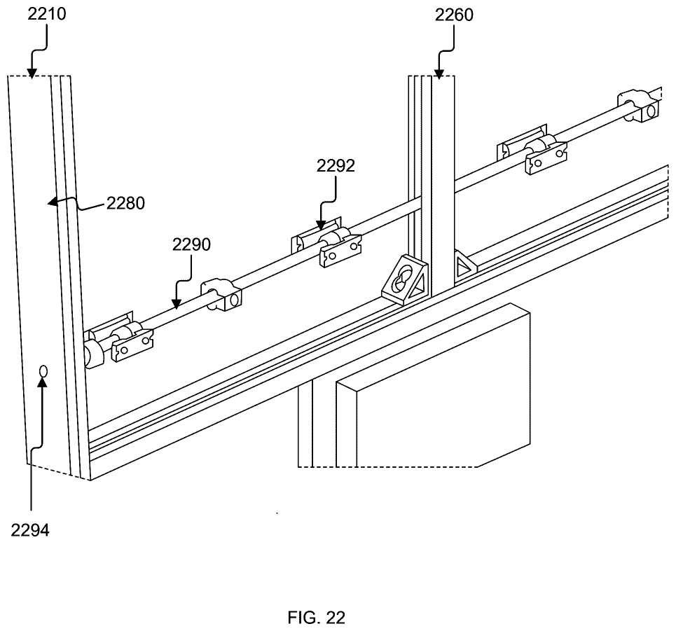

Each of the plurality of interchangeable panels 2020 is configured to be individually and separately removable from the door 2010. The specific mechanism facilitating the removal and attachment of each panel 2020 will be described in further detail in relation to FIGS. 22A-22C.

In some embodiments, one or more of the panels 2020 may be constructed from a fully opaque material to provide privacy and security. Such materials may include, by way of non-limiting example, wood, metal, composite materials, or high-density polymers. In other embodiments, one or more of the interchangeable panels 2020 may be configured as a display panel. Such a display panel may utilize various technologies to present static or dynamic visual elements. For presenting static displays, such as a fixed pattern, texture, or digital artwork, the panel 2020 may comprise electronic ink (E-ink) or a printed film. For dynamic, user-programmable displays, the panel 2020 may comprise a screen, such as a liquid crystal display (LCD), light-emitting diode (LED), or organic light-emitting diode (OLED) display. These programmable panels may interface with an external computing device 1910, allowing a user to display content such as photographs, calendar schedules, weather forecasts, delivery information, contact information, menus for restaurants, services provided by a business, or animations. Further still, a panel 2020 may be fabricated from a translucent material, such as frosted glass or polycarbonate, to permit the passage of light while obscuring direct visibility.

In another embodiment, a display panel 2020 may further include an integrated, transparent energy storage module, such as a thin-film battery or a supercapacitor array. This storage module can be electrically coupled to the panel's power receiving mechanism and configured to be continuously trickle-charged during normal operation. A control system within the panel can manage power consumption by drawing from the primary power source and seamlessly switching to the integrated storage module as a backup. This ensures the display can remain operational during intermittent power transmission, enhancing system reliability.

The dividers 2030, positioned between the interchangeable panels 2020, may serve both aesthetic and functional purposes. In some embodiments, each divider 2030 may comprise one or more integrated light strips. These light strips may be configured to be separately controllable, allowing a user to independently adjust the illumination properties, such as brightness, color, and power state, for each divider. This control may be executed through the access control panel or remotely via a software application running on a computing device 1910, providing customizable accent lighting or status indications (e.g., glowing green when a door is unlocked).

In other embodiments, one or more dividers 2030 may have at least one camera embedded within its structure, positioned to discreetly monitor the area in front of the door. The dividers 2030 may also be fabricated from various materials to achieve different visual effects; for example, they may be made of frosted or translucent glass to diffuse the light from the integrated light strips. The dividers 2030 may also serve as a structural component of the insertion mechanism. For instance, a divider 2030 may act as the primary retaining mechanism for the interchangeable panels 2020, featuring a channel that secures the edges of adjacent panels. Alternatively, the dividers 2030 may incorporate guide rails, similar to the guide rail 1820 previously described, onto which the panels 2020 are slidably mounted.

The access control panel 2040, integrated within one of the interchangeable panels 2020 or provided as a separate section within the door 2010, comprises the components for user interaction and security. These components include the door handle 2041, the electronic locking mechanism 2042, and the physical key entry point 2043. The door handle 2041 is mechanically coupled to a latching mechanism, such that physically actuating the handle retracts the latch and permits the door to be opened. The electronic locking mechanism 2042 and the physical key entry point 2043 can be configured to operate in various security modes. In one mode, they may function as alternatives, where either a valid electronic credential or a physical key will disengage the lock. In a heightened security mode, both an electronic credential and a physical key may be required for authentication. Furthermore, the electronic locking mechanism 2042 may be configured for remote operation via a wireless remote control or a mobile application on a computing device 1910.

In other embodiments, the components of the entry interface assembly may have alternative configurations. The door handle 2041, for instance, may be a motorized, retractable handle that remains flush with the panel surface until the lock is disengaged, providing a sleeker aesthetic. The remote-control capabilities of the electronic locking mechanism 2032 can be expanded to include proximity-based unlocking via protocols such as Bluetooth® or NFC when an authorized device is detected. The mobile application may also be configured to generate temporary or single-use electronic keys for guests or service personnel. Additionally, the security modes may include a “lockdown” feature that electronically disables both the physical and electronic entry methods until deactivated by a primary user, providing additional security in an emergency.

One or more of the interchangeable panels 2020 may include a peephole 2050. In some embodiments, the peephole 2050 may comprise a standard optical assembly, such as a fisheye lens, that is mounted through the panel to allow an occupant to visually identify visitors before opening the door 2010.

In other embodiments, the peephole 2050 may be implemented as a digital camera system. The camera may be configured for continuous, active monitoring, or it may be activated by a trigger event to conserve power or enhance privacy. Such triggers may include a knock on the door, detected by pressure or vibration sensors integrated into the panels 2020, or the press of a doorbell. The system may further integrate this camera with the electronic locking mechanism 2042 through a facial recognition module. In such a configuration, the locking mechanism 2042 can be programmed to disengage automatically upon identifying an authorized user, serving as an alternative to NFC or other proximity-based unlocking methods. Furthermore, a user may program the system, via a mobile application on the computing device 1910, to recognize guests or service personnel and grant them temporary access, for instance, by unlocking the door for a single entry during a specified time window. In other embodiments, the system may be programmed to unlock the door 2010 when it detects emergency response personnel, such as first responders (police officers, fire responders, EMTs.

In some embodiments, at least one of the interchangeable panels 2020 may be configured as a secure package delivery module. This module may comprise a compartment accessible via an exterior door that is separate from the main door 2010. The exterior door of the module may be secured by its own electronic lock that is communicatively coupled to the main access control system. A user may generate a temporary or single-use access code via the mobile application on computing device 1910 and provide it to a delivery service. Upon entering the code, a courier may open the module, deposit a package, and securely close the door, at which point the code may expire. In other embodiments, the secure package delivery module may be coupled to a wireless communication module to alert the user that a package is delivered via push notifications on a mobile application, or via text messaging. In other embodiments, the access code may be multi-use.

In other embodiments, the package delivery module may be scalable, configured to occupy the space of two or more panels 2020 to accommodate larger items. The module may also include one or more internal sensors, such as a weight or optical sensor, to automatically detect the presence of a package and transmit a delivery confirmation notification to the user's mobile device. For the delivery of perishable goods, the module may be thermally insulated and equipped with a thermoelectric heating or cooling element to maintain a desired temperature. Further, the module may incorporate a sanitization feature, such as an integrated ultraviolet (UV-C) light source that activates after a delivery to disinfect the contents of the compartment.

In other embodiments, one of the interchangeable panels 2020 may be configured as an environmental sensing module. Such a module may be equipped with a suite of sensors to measure and report on the conditions immediately outside the door 2010. These sensors can include, by way of non-limiting example, a thermometer for temperature, a hygrometer for humidity, a barometer for atmospheric pressure, and an air quality sensor for detecting particulate matter (e.g., PM2.5) and pollen. Data collected by these sensors may be displayed in real-time on a digital display panel 2020 or transmitted to the mobile application on the computing device 1910, providing the user with actionable alerts and environmental information.

In other embodiments, the environmental sensing module may be configured to interact with other smart home systems. For instance, upon detecting poor exterior air quality, the module could automatically send a signal to the home's HVAC system to close fresh air intakes or activate an air purification mode. The module could also include a UV sensor to report the current UV index or a sound sensor to function as a decibel meter, monitoring and logging ambient noise levels. A precipitation sensor could also be integrated to detect rain or snow, triggering a notification to the user's device.

In other embodiments, the environmental sensing module's control system is configured to connect to external data networks. This allows the system to retrieve predictive environmental data, such as local weather forecasts, pollen counts, or regional air quality alerts. The control system can process this predictive data in conjunction with real-time measurements from its own sensor suite. For example, if a high-pollen event is forecast, the system can proactively perform an air filtration cycle before the event occurs and then reduce external air intake during the peak period, thereby optimizing air quality.

In some embodiments, one of the interchangeable panels 2020 may be configured as an emergency egress and information module, designed to provide assistance during a power outage or other emergencies. This module may contain a dedicated, rechargeable battery and a high-efficiency LED light strip. Upon detection of a loss of mains power, the light strip automatically illuminates the threshold of the door 2010, ensuring a safe path of egress. The panel may also feature a low-power E-ink display that, in an emergency, presents critical information such as the home address or pre-programmed emergency contacts. Concurrently, the light strips within the dividers 2030 may be programmed to flash in a universally recognized emergency color, such as red, to attract the attention of first responders.

In other embodiments, the emergency module may include a battery-backed speaker to broadcast audible alarms or pre-recorded evacuation instructions. To enhance resilience, it may incorporate a low-power, wide-area network (e.g., LoRaWAN) transmitter to send an emergency signal even if local Wi-Fi and cellular services are unavailable. The module may also integrate its own smoke and carbon monoxide detectors, providing redundant safety monitoring at a critical point of egress. Furthermore, the panel could feature a visible mechanical indicator to provide positive confirmation that any electronic lockdown modes have been successfully overridden, assuring occupants of their ability to exit.

In some embodiments, one or more of the interchangeable panels 2020 may be configured to harvest ambient energy to power the various electronic components of the door system. The exterior surface of such a panel may comprise photovoltaic solar cells. These cells may be electrically connected to an internal power management system, including a charge controller and a rechargeable battery pack housed within the panel or the main body of the door 2010. This configuration allows the system to power the electronic lock 2042, camera 2050, and lights 2030 in a self-sufficient manner, enhancing reliability and resilience against power outages.

In other embodiments, the energy harvesting capabilities may be augmented with a kinetic energy harvesting system, which generates electrical charge from the physical motion of the door 2010 opening and closing. The stored energy could be made accessible to the user via a powered USB port, or other power delivery interface, integrated into an interior-facing panel, allowing for the charging of mobile devices during a power failure. The photovoltaic technology may utilize transparent or semi-transparent solar cells, enabling them to be integrated into a window or display panel without completely obstructing the view. A display panel could also be configured to show real-time power metrics, including battery level, current generation, and consumption.

In some embodiments, an interchangeable panel 2020 may be configured to provide acoustic management. In a passive configuration, the panel is constructed using high-density, sound-absorbing materials, such as mass-loaded vinyl or specialized acoustic foam, to dampen the transmission of exterior noise into the building. In an active configuration, the panel incorporates an active noise cancellation (ANC) system. This system may use one or more exterior-facing microphones to detect the frequency and amplitude of ambient sound waves and an interior-facing speaker or transducer to generate an opposing, out-of-phase sound wave that effectively cancels the unwanted noise.

In other embodiments, the ANC system may be adaptive, using a processor to analyze the soundscape in real-time and adjust the cancellation algorithm for optimal performance. The system could also be programmed for selective sound passthrough, allowing it to cancel general background noise like traffic while permitting specific frequencies, such as those of a human voice or an emergency siren, to be heard. The microphones and speakers used for ANC could also serve a dual purpose as a high-fidelity intercom system. The panel's mounting may further incorporate elastomeric materials to decouple it from the door 2010, reducing the transmission of structural vibrations in addition to airborne sound.

Referring now to FIG. 21, a view of the internal structure of an exemplary door 2110 of an interchangeable door system 2100, according to some embodiments of the present disclosure, is illustrated. The door 2110 comprises an internal frame built from a plurality of vertical and horizontal support beams 2160. These beams provide structural rigidity and define the cavities that receive the interchangeable panels 2120 and dividers 2130. To enhance the frame's strength and torsional stability, gussets 2165 (triangular supports) may be fixed at the intersections of the support beams 2160 with each other and with the outer frame. Housed within one of the internal cavities is an electronic control unit 2170, which serves as the central processing hub for the door's smart features. The electronic control unit 2170 may include a processor and a wireless communication device for interfacing with other systems, and it is electrically coupled to a power source, such as a battery 2172.

In other embodiments, the internal structure may be configured differently. The support beams 2160 and gussets may be fabricated from various materials, such as engineered wood or reinforced polymer composites, as an alternative to metal, to achieve different weight and cost objectives. The support beams 2160 may be substantially hollow or feature integrated conduits, providing protected pathways for routing wiring between the electronic control unit 2170 and the various electronic modules throughout the door. Furthermore, the battery 2172 may be a backup power source for a primary hardwired connection to the building's electrical supply. The electronic control unit 2170 itself may be environmentally sealed for protection and could be part of a distributed system with multiple redundant processors for enhanced reliability.

In another embodiment, the internal frame of the door 2110 may be adjustable to provide for dynamic panel sizing. The support beams 2160 may be configured as telescoping members with locking mechanisms or as a modular T-slot extrusion system. This allows a user to modify the internal layout of the frame, changing the size and orientation of the cavities that receive the interchangeable panels 2120. For example, a divider 2130 could be removed and the adjacent support beams 2160 repositioned to accommodate a single, larger panel, thereby enhancing the modularity and long-term adaptability of the entire system.

The structural components of the door 2110, including the outer frame, support beams 2160, and gussets, may be fabricated from a variety of materials selected based on desired properties such as strength, weight, and aesthetics. In some embodiments, the frame may be constructed from metal to provide high durability and security. For example, steel may be utilized for maximal rigidity and impact resistance, whereas aluminum may be selected for its excellent strength-to-weight ratio and natural corrosion resistance. Alternatively, the frame may be constructed from wood, such as solid hardwoods or engineered wood products like Laminated Veneer Lumber (LVL), to provide a traditional appearance, natural insulation, and ease of manufacturing.

In other embodiments, the frame may be constructed from advanced or hybrid materials. For instance, composite materials such as a fiberglass or carbon fiber reinforced polymer may be used to fabricate a frame that is exceptionally strong, lightweight, and dimensionally stable, resisting warping due to changes in temperature or humidity. The frame may also feature a hybrid construction; wherein different materials are used in combination. As a non-limiting example, the primary load-bearing support beams 2160 could be made of steel, while other internal components are made from a polymer to reduce weight, with the entire structure being clad in a decorative wood veneer. Furthermore, the frame could be fabricated using recycled or sustainable materials to reduce the environmental impact of the product.

The gussets 2165 may be affixed to the support beams 2160 and the main door frame 2110 using a variety of fastening methods, wherein the chosen method may depend on the construction materials of the frame. In embodiments with a metal frame, such as steel or aluminum, the gussets 2165 may be permanently joined by welding to create a strong, monolithic structure. Alternatively, mechanical fasteners may be utilized. For metal frames, gussets 2165 may be secured using bolts or rivets. For wooden frames, metal or wooden gussets may be attached using fasteners such as wood screws or lag bolts, often in combination with a structural adhesive to enhance the joint's rigidity and prevent loosening over time.

In other embodiments, alternative or advanced joining methods may be employed. For frames constructed from composite or polymer materials, the gussets may be attached using high-strength structural bonding agents, such as epoxy, which can provide a durable bond that distributes stress evenly across the joint. In some manufacturing processes, the gussets may not be separate components but may be integrated directly into the frame. For instance, if the frame is produced by casting, injection molding, or is machined from a single billet of material, the gussets can be formed as integral, reinforced corners of the support structure. For wooden frames, traditional joinery, such as dovetail or mortise and tenon joints, could be used to create strong, interlocking connections between the frame components.

The electronic control unit (ECU) 2170 functions as the central nervous system for the interchangeable door system, executing the commands and processing the data for its various smart features. The ECU 2170 comprises, at a minimum, a processor configured to run coded software instructions and a wireless communication unit. The wireless communication unit, which may utilize one or more protocols such as Wi-Fi, Bluetooth®, Zigbee, Z-Wave, Thread, and/or HomeKit Accessory Protocol (HAP), enables the door to interface with a user's mobile computing device 1910 and other smart home devices. The ECU 2170 is communicatively and electrically coupled to the active modules within the door, including, but not limited to, the access control panel 2040, the digital camera 2050, the controllable light strips located in the dividers 2030, and various other sensors that may be included in the system 2100.

In other embodiments, the ECU 2170 may include additional components to enhance its capabilities. The ECU 2170 may incorporate onboard non-volatile memory for storing firmware, user access logs, and video data captured by the camera 2050. It may also include specialized co-processors, such as a neural processing unit (NPU), to efficiently process complex tasks like real-time facial recognition algorithms locally on the device. For connectivity, in addition to its wireless unit, the ECU 2170 may feature a wired Ethernet port for a secure, high-speed connection to a local network. Furthermore, the ECU 2170 may include a sophisticated power management module to optimize energy consumption from the battery 2172 by placing inactive components in a low-power state and to manage power from any integrated energy-harvesting systems.

To ensure safe operation of any motorized components within the interchangeable door system, the electronic control unit (ECU) 2170 may be configured to provide adaptive force control and obstruction detection. The ECU 2170 can continuously monitor the electrical current draw of any connected motor, such as the motor for a retractable handle 2041 or a motorized retention mechanism 2290. If the ECU detects a spike in motor current inconsistent with normal operation, it can interpret this as an obstruction and immediately halt or reverse the motor's movement to prevent damage or injury, and may send an alert to the user.

To enhance the physical security of the door's electronic systems, the electronic control unit 2170 and its power source 2172 may be housed within a hardened, tamper-resistant vault integrated into the door frame. This vault may be constructed from drill-resistant or reinforced materials to protect the core electronic components from physical attack or tampering. The vault may further be equipped with one or more tamper-detection sensors configured to trigger an immediate system-wide alarm, activate a lockdown of the electronic lock 2042, and send a security alert to the user if a physical breach is attempted.

To ensure the long-term viability and technological relevance of the system, the electronic control unit 2170 and battery 2172 may be configured as a single, self-contained, and user-replaceable electronics core. This modular cartridge may connect to the door's internal wiring harness through a standardized docking port or multi-pin connector allowing a user to easily upgrade the door's performance and capabilities without needing to replace the entire door, thereby future proofing the initial investment. For instance, the user may swap a future cartridge with a more powerful processor or a new wireless communication standard.

In a further embodiment, the internal structure may be configured as an integrated thermal and fire management system. The cavities within the door frame, defined by the support beams 2160, may be filled with a high-performance, fire-retardant insulation material, such as mineral wool or aerogel, to improve the door's thermal resistance and fire rating. To provide an active safety feature, one or more temperature sensors may be placed within the door and communicatively coupled to the electronic control unit 2170. Upon detecting a rapid temperature increase indicative of a fire, the ECU 2170 can be programmed to sound an alarm or transmit an emergency alert to the user's computing device 1910, potentially providing an earlier warning than an interior smoke detector.

Referring now to FIG. 22, a detailed view of a retention mechanism for securing one or more interchangeable panels of an interchangeable door system 2200 is illustrated, according to some embodiments of the present disclosure. FIG. 22 shows a portion of the internal structure of the door 2210, including a vertical support beam 2260 and a vertical member of the outer frame 2280. The mechanism comprises a retention rod 2290 that is rotatably mounted so as to pass through an aperture in the support beam 2260. Fixed along the length of the retention rod 2290 is a plurality of retention clasps 2292. A user can actuate the mechanism by inserting a tool, such as an Allen key or a screwdriver, into an engagement point at the end of the rod 2290, which is accessible via an access point 2294 on the side of the outer frame 2280. Rotating the rod 2290 causes the clasps 2292 to pivot between an unlocked position and a locked position, where they engage a corresponding retention beam (not shown) to hold the interchangeable panel securely in place.

The quantity and placement of the retention mechanisms within the door 2110 are configured to correspond with the arrangement of the interchangeable panels 2020. In some embodiments, a discrete retention mechanism, as detailed in FIG. 22, may be installed within the internal structure of the door adjacent to each divider 2030. This configuration positions a retention system horizontally between each pair of interchangeable panels, allowing each panel to be independently secured and released by its own dedicated mechanism.

In other embodiments, the door frame may be designed to accommodate various panel sizes and configurations by incorporating a plurality of retention system installation points at different vertical intervals. This allows a user to install retention mechanisms in non-standard locations to support larger or smaller custom panels, effectively creating a redundant and reconfigurable locking grid. Alternatively, a single retention rod may extend the full vertical length of the door, featuring a multitude of retention clasps 2292 along its length. In such a system, any vertical arrangement of panels may be secured, as the clasps at the appropriate locations may engage with the panels'retention beams, providing a universal locking solution that is inherently adaptable to different layouts.

In other embodiments, the retention mechanism may be configured with alternative features. The actuation of the retention rod 2290 may be motorized, wherein a small electric motor coupled to the rod 2290 and controlled by the ECU 2170 allows for automated or remote locking and unlocking of the panels via the mobile application. The retention rod 2290 itself may feature a non-circular cross-section, such as a hexagon or square, to ensure a positive, non-slip engagement with both the retention clasps 2292 and the actuating tool or motor. Furthermore, the mechanism may include one or more sensors communicatively coupled to the ECU 2170 to provide feedback, confirming the locked or unlocked status of the panels and displaying this state to the user.

In another embodiment designed to enhance the manual operation of the retention mechanism, the engagement point of the retention rod 2290, accessible via the access point 2294, may be integrated with a mechanical torque-limiting clutch. This clutch may be configured to disengage with an audible or tangible click once a predetermined optimal torque has been applied, which prevents a user from over-tightening the mechanism and potentially damaging the retention clasps 2292 or the panel. To provide further non-powered user feedback, a mechanical visual indicator may be coupled to the retention rod 2290. This indicator, for example a colored pin that protrudes from the side of the outer frame 2280 or an indicator window that changes from red to green, provides immediate and unambiguous visual confirmation that the rod has been fully rotated into its locked position.

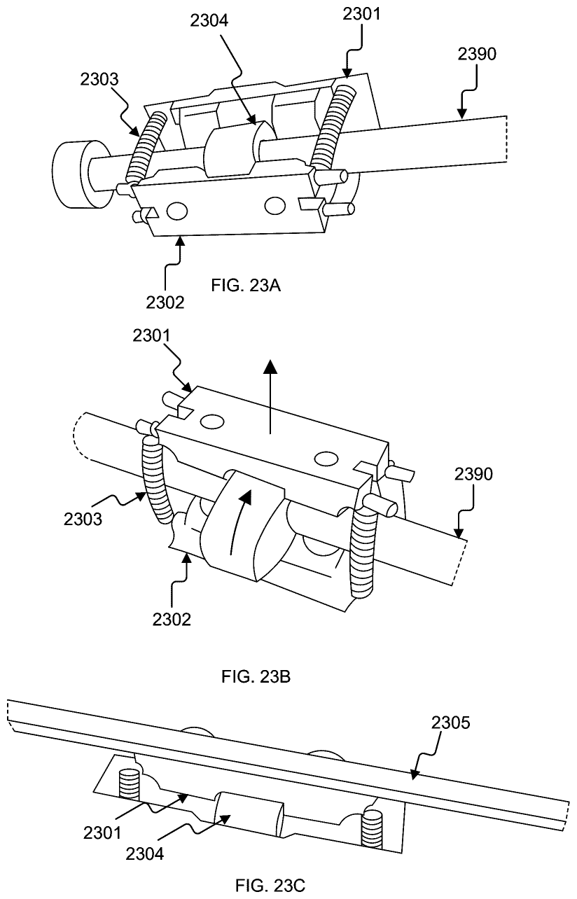

Referring now to FIG. 23A, a detailed view of an exemplary retention clasp 2392 is shown in its locked position, according to some embodiments of the present disclosure. The clasp 2292 comprises an internal pad 2301 and an external pad 2302, which are held in a parallel, spaced-apart relationship by a plurality of resilient members, such as springs 2303. The internal pad 2301 and the external pad 2302 may be joined with a retention beam (not shown) using mechanical or chemical attachment mechanism. The retention rod 2290 passes through the center of the clasp between the pads. Fixedly integrated with the retention rod 2290 within the clasp is a pin 2304 that functions as a cam. As illustrated in the locked position, the pin 2304 is in a disengaged orientation (e.g., its narrowest dimension is between the pads), allowing the springs 2303 to apply a strong clamping force, pulling the pads 2301, 2302 together to grip and secure a retention feature on an interchangeable panel. To unlock the mechanism, the retention rod 2290 is rotated, causing the cam-shaped pin 2304 to push the pads apart, overcoming the spring force and releasing the panel.

In other embodiments, the components of the retention clasp 2292 may vary. The pads 2301, 2302 may be fabricated from metal or a durable polymer, and their outer contact surfaces may be coated or overmolded with a high-friction, non-marring material like rubber or urethane to improve grip and protect finished surfaces. The springs 2303 may be coil springs as depicted, or they could be elastomeric bushings or leaf springs. The pin 2304 may be designed with different cam profiles to alter the locking feel and force characteristics. Furthermore, the entire clasp assembly, including the pads and the cam feature of the pin 2304, may be formed as an integral part of the retention rod 2290 through a process like forging or casting, creating a single, robust component rather than an assembly of individual parts.

FIG. 23B illustrates the retention clasp 2292 transitioning to an unlocked state, according to some embodiments of the present disclosure. As the retention rod 2390 is rotated, the integrated pin 2304 functions as a cam, forcing the internal pad 2301 away from the retention rod 2290 and overcoming the restorative force of the springs 2303. The pin 2304 may feature an asymmetric cam profile to allow for independent unlocking of panels on either side of the door. For instance, rotating the retention rod 2390 in a first direction may cause the cam to primarily displace the internal pad 2301, disengaging an interior panel, while rotating the rod in the opposite direction may primarily displace the external pad 2302 to release an exterior panel.

In other embodiments, the pin 2304 may be manufactured with a symmetric cam profile, such that rotating the retention rod 2390 in either direction forces both pads 2301, 2302 away from the retention rod 2390 simultaneously to release both internal and external panels at the same time. The retention mechanism may also include mechanical detents that provide tactile feedback to the user, creating distinct stop positions for the locked, internal-unlocked, and external-unlocked states. For applications where interchangeable panels are only present on one side of the door, the clasp 2292 may be a single-sided design, where one of the pads is fixed and only the other moves to engage and disengage the panel.

FIG. 23C illustrates the retention clasp 2292 in a fully unlocked state, showing the disengagement of a retention beam 2305, according to some embodiments of the present disclosure. The retention beam 2305 is a structural component affixed to an internal or external pad. In the unlocked state, the rotated cam-shaped pin 2304 holds the internal pad 2301 (and the corresponding retention beam 2305) in a separated position, creating a sufficient gap to release the clamping force. As shown, the retention beam 2305 is disengaged from the associated interchangeable panel, which permits the installation or removal of the associated interchangeable panel from the door frame. A single retention beam 2305 may be coupled with multiple retention clasps.

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

What is claimed is:

1. An interchangeable door system, comprising:
a door including an internal frame;
at least one interchangeable door panel configured to be removably received within the internal frame of the door; and
at least one retention mechanism configured to removably secure the at least one interchangeable door panel within the internal frame, the at least one retention mechanism including:
a rotatable retention rod; and
at least one retention clasp affixed to the rotatable retention rod; wherein rotation of the rotatable retention rod causes the at least one retention clasp to transition between a locked state and an unlocked state to secure or release the at least one interchangeable door panel.

2. The interchangeable door system of claim 1, wherein the at least one retention clasp includes:
an internal pad and an external pad;
at least one resilient member coupling the internal pad to the external pad; and
a cam fixedly integrated with the rotatable retention rod and positioned between the internal pad and the external pad.

3. The interchangeable door system of claim 2, wherein, in the locked state, the at least one resilient member provides a clamping force by pulling the internal pad and the external pad towards each other to grip the at least one interchangeable door panel, and wherein rotation of the cam overcomes the clamping force to transition the at least one retention clasp to the unlocked state.

4. The interchangeable door system of claim 1, further including a retention beam fixedly attached to the at least one retention clasp, and wherein, in the locked state, the retention beam grips the at least one interchangeable door panel.

5. The interchangeable door system of claim 1, further including an electronic control unit housed within the internal frame, the electronic control unit including a processor and a wireless communication unit.

6. The interchangeable door system of claim 5, further including a motor coupled to the rotatable retention rod, wherein the electronic control unit is configured to control the motor to rotate the rotatable retention rod between the locked state and the unlocked state.

7. The interchangeable door system of claim 1, wherein the internal frame includes a plurality of adjustable support beams, allowing a user to reconfigure a size of the plurality of cavities.

8. The interchangeable door system of claim 1, wherein the internal frame comprise one or more insulating materials.

9. The interchangeable door system of claim 8, wherein the one or more insulating materials comprise one or more of: polyvinyl chloride, one or more polycarbonates, one or more thermoplastic polymers, or aerogel.

10. The interchangeable door system of claim 1, wherein the at least one interchangeable door panel comprises an electronic device.

11. The interchangeable door system of claim 10, wherein the electronic device comprises a display mechanism.

12. The interchangeable door system of claim 11, wherein the display mechanism at least partially comprises smart glass.

13. The interchangeable door system of claim 12, wherein the electronic device comprises at least one of: a camera, a light emitting device, an audio emitting device, or a biometric scanner.

14. The interchangeable door system of claim 13 wherein the display mechanism is configured to display one or more of an image, a menu, or a description of services.

15. The interchangeable door system of claim 1, wherein the door further includes one or more sensors to detect environmental conditions.

16. A method for interchanging a panel on a door, wherein the method including:
providing a door including an internal frame and a retention mechanism, the retention mechanism including a rotatable retention rod coupled to a clasp, wherein the clasp provides a clamping force in a locked state and releases the clamping force in an unlocked state;
rotating the rotatable retention rod to transition the clasp from the locked state to the unlocked state;
removing a first interchangeable door panel from the cavity;
inserting a second interchangeable door panel into the cavity; and
rotating the rotatable retention rod to transition the clasp from the unlocked state back to the locked state, thereby securing the second interchangeable door panel within the cavity with the clamping force.

17. The method of claim 16, wherein the step of rotating the rotatable retention rod to transition the at least one retention clasp to the unlocked state includes rotating a cam integrated with the rotatable retention rod to force an internal pad and an external pad of the at least one retention clasp apart from each other.

18. The method of claim 16, wherein the step of rotating the rotatable retention rod to transition the at least one retention clasp to the locked state includes rotating a cam integrated with the rotatable retention rod to allow at least one resilient member to pull an internal pad and an external pad of the at least one retention clasp towards each other to grip the second interchangeable door panel.

19. The method of claim 16, further including the step of reconfiguring a size of one or more cavities within the internal frame by adjusting a plurality of adjustable support beams prior to the step of inserting the second interchangeable door panel.

20. The method of claim 16, wherein the steps of rotating the rotatable retention rod are performed by an electric motor in response to one or more commands from an electronic control unit housed within the internal frame.
